(19) United States
(12) Patent Application Publication
(10) Pub. No.: US 2026/0005743 A1
(43) Pub. Date: Jan. 1, 2026

(54) BEAM INDICATIONS FOR WIRELESS DEVICE-SIDED TIME DOMAIN BEAM PREDICTIONS

(71) Applicant: Telefonaktiebolaget LM Ericsson (publ), Stockholm (SE)

(72) Inventors: Andreas NILSSON, Göteborg (SE); Jingya LI, Göteborg (SE); Icaro Leonardo DA SILVA, Solna (SE); Chunhui LI, Yokohama, Kanagawa (JP)

(21) Appl. No.: 18/992,308

(22) PCT Filed: Aug. 3, 2023
(86) PCT No.: PCT/SE2023/050774

§ 371 Date: Jan. 8, 2025

Related U.S. Application Data
(60) Provisional application No. 63/395,609, filed on Aug. 5, 2022.

(51) Int. Cl. H04B 7/06; H04W 24/10

(52) U.S. Cl. CPC H04B 7/0626; H04B 7/06952; H04W 24/10

(57) ABSTRACT

A method, network node and wireless device (WD) for beam indications for WD-sided time domain beam predictions, are disclosed. According to one aspect, a method in a WD includes receiving from a network node a channel state information (CSI) reporting configuration indicating a first set of future time instances for CSI predictions to be reported by the WD. The method includes performing a time sequence of measurements on a set of reference signal beams transmitted by the network node. The method also includes transmitting a beam information report that includes CSI predictions the first set of future time instances, the CSI predictions based at least in part on the time sequence of measurements. The method further includes receiving a beam indication indicating at least one selected beam for the CSI predictions to be autonomously applied by the WD at a second set of future time instances.

### TECHNICAL FIELD

The present disclosure relates to wireless communications, and in particular, to beam indications for wireless device (WD)-sided time domain beam predictions.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

### Beam Management

### Beam Management Procedure

In high frequency range (FR2), multiple radio frequency (RF) beams may be used to transmit and receive signals at a network node (e.g., gNB) and a wireless device (WD) WD. For each downlink (DL) beam from a network node, there is typically an associated best wireless device receive (Rx) beam for receiving signals from the DL beam. The DL beam and the associated wireless device Rx beam forms a beam pair. The beam pair may be identified through a so-called beam management process in NR.

A DL beam is (typically) identified by an associated DL reference signal (RS) transmitted in the beam, either periodically, semi-persistently, or aperiodically. The DL RS for the purpose may be a Synchronization Signal (SS) and Physical Broadcast Channel (PBCH) block (SSB) or a Channel State Information RS (CSI-RS). By measuring all the DL RSs, the wireless device may determine and report to the network node the best DL beam to use for DL transmissions. The network node may then transmit a burst of DL-RS in the reported best DL beam to let the wireless device evaluate candidate wireless device Rx beams.

Although not explicitly stated in the NR specification, beam management has been divided into, for example, three procedures (P-1 (P1 procedure) to P-3 (P3 procedure)). These three procedures are schematically illustrated in the example of FIG. 1:
P-1: Purpose is to find a coarse direction for the wireless device using wide network node Tx beam covering the whole angular sector;
P-2: Purpose is to refine the network node Tx beam by performing a new beam search around the coarse direction found in P1; and
P-3: Used for a wireless device that has analog beamforming to let the wireless device find a suitable wireless device Rx beam.

P-1 is expected to utilize beams with rather large beamwidths and where the beam reference signals are transmitted periodically and are shared between all wireless devices of the cell. Reference signals used for P-1 are periodic CSI-RS or SSB. The wireless device then reports the N best beams to the network node and their corresponding reference signal received power (RSRP) values.

P-2 is expected to use aperiodic/or semi-persistent CSI-RS transmitted in narrow beams around the coarse direction found in P-1.

P-3 is expected to use aperiodic or semi-persistent CSI-RSs repeatedly transmitted in one narrow network node beam. One alternative way is to let the wireless device determine a suitable wireless device Rx beam based on the periodic SSB transmission. Since each SSB consists of four orthogonal frequency division multiplexed (OFDM) symbols, a maximum of four wireless device Rx beams may be evaluated during each SSB burst transmission. One benefit with using SSB instead of CSI-RS is that no extra overhead of CSI-RS transmission is needed.

### Beam Indication

In NR, several signals may be transmitted from different antenna ports of a same network node. These signals may have the same large-scale properties such as Doppler shift/spread, average delay spread, or average delay. These antenna ports are considered to be quasi co-located (QCL).

If the wireless device knows that two antenna ports are QCL with respect to a certain parameter (e.g., Doppler spread), the wireless device may estimate that parameter based on one of the antenna ports and apply that estimate for receiving signals on the other antenna port.

For example, there may be a QCL relation between a channel state information-reference signal (CSI-RS) for a tracking reference signal (TRS) and the physical downlink shared channel (PDSCH) demodulation reference signal (DMRS). When wireless device receives the PDSCH DMRS, the WD may use the measurements already made on the TRS to assist the DMRS reception.

Information about what assumptions may be made regarding QCL is signaled to the wireless device from the network node. In NR, four types of QCL relations between a transmitted source RS and transmitted target RS have been defined:
Type A: {Doppler shift, Doppler spread, average delay, delay spread};
Type B: {Doppler shift, Doppler spread};
Type C: {average delay, Doppler shift}; and
Type D: {Spatial Rx parameter}.

QCL type D was introduced in NR to, for example, facilitate beam management with analog beamforming and is known as spatial QCL. There is currently no strict definition of spatial QCL, but the understanding is that if two transmitted antenna ports are spatially QCL, the wireless device may use the same Rx beam to receive them. This is helpful for a wireless device that uses analog beamforming to receive signals, since the wireless device needs to adjust its Rx beam in some direction prior to receiving a certain signal. If the wireless device knows that the signal is spatially QCL with some other signal it has received earlier, then the wireless device may safely use the same Rx beam to also receive this signal.

In NR, the spatial QCL relation for a DL or UL signal or channel may be indicated to the wireless device by using a “beam indication”. The “beam indication” is used to help the wireless device to find a suitable Rx beam for DL reception, and/or a suitable Tx beam for UL transmission. In NR, the “beam indication” for DL is conveyed to the wireless device by indicating a transmission configuration indicator (TCI) state to the wireless device, while in UL the “beam indication” may be conveyed by indicating a DL-RS or UL-RS as spatial relation (in NR 3GPP Technical Releases 15 and 16 (3GPP Rel-15/16)) or a TCI state (in 3GPP Rel-17)).

Beam Management with Unified TCI Framework

In NR, downlink beam management is performed by conveying spatial QCL (‘Type D’) assumptions to the wireless device through TCI states.

In NR 3GPP Rel-15 and 3GPP Rel-16, for physical downlink control channel (PDCCH), the network (NW) or network node configures the wireless device with a set of PDCCH TCI states by radio resource control (RRC) signaling, and then activates one TCI state per control resource set (CORESET) using medium access control (MAC) control elements (CE). For PDSCH beam management, the NW/network node configures the wireless device with a set of PDSCH TCI states by RRC, and then activates up to 8 TCI states by MAC CE. After activation, the NW/network node dynamically indicates one of these activated TCI states using a TCI field in downlink control information (DCI) when scheduling PDSCH.

Such a framework allows for more flexibility for the network/network node to instruct the wireless device to receive signals from different spatial directions in DL with a cost of large signaling overhead and slow beam switch. These limitations are particularly noticeable and costly when wireless device movement is considered. One example is that beam update using DCI may only be performed for PDSCH, and MAC-CE or RRC is required to update the beam for other reference signals or channels, which causes extra overhead and latency.

Furthermore, in majority of cases, the network/network node transmits to and receives from a wireless device in the same direction for both data and control. Hence, using separate framework (TCI state respective spatial relations) for different channels or signals complicates the implementations.

In 3GPP Rel-17, a common beam framework was introduced to help simplify beam management in FR2, in which a common beam represent by a TCI state may be activated or indicated to a wireless device and the common beam is applicable for multiple channels or signals such as PDCCH and PDSCH. The common beam framework is also referred to as a unified TCI state framework.

The new framework may be RRC configured in one out two modes of operation, i.e., “Joint DL/UL TCI” or “Separate DL/UL TCI”. For “Joint DL/UL TCI”, one common Joint TCI state is used for both DL and UL signals/channels. For “Separate DL/UL TCI”, one common DL-only TCI state is used for DL channels/signals and one common UL-only TCI state is used for UL signals/channels.

A unified TCI state may be updated in a way that is similar to the TCI state update for PDSCH in 3GPP Rel-15/16, i.e., with one of two alternatives:
Two-stage: RRC signaling is used to configure a number of unified TCI states in higher layer parameter PDSCH-config, and a MAC-CE is used to activate one of unified TCI states; and
Three-stage: RRC signaling is used to configure a number of unified TCI states in PDSCH-config, a MAC-CE is used to activate up to 8 unified TCI states, and a 3-bit TCI state bitfield in DCI is used to indicate one of the activate unified TCI states.

The one activated or indicated unified TCI state may be used in subsequent both PDCCH and PDSCH transmissions until a new unified TCI state is activated or indicated.

The existing DCI formats 1_1 and 1_2 are reused for beam indication, both with and without DL assignment. For DCI formats 1_1 and 1_2 with DL assignment, acknowledgement/negative acknowledgement (ACK/NACK) of the PDSCH may be used as indication of successful reception of beam indication. For DCI formats 1_1 and 1_2 without DL assignment, a ACK/NACK mechanism is used that is analogous to that for a semi-persistent scheduling (SPS) PDSCH release with both type-1 and type-2 hybrid automatic repeat request (HARQ)-ACK codebooks. Upon a successful reception of the beam indication DCI, the WD reports an ACK.

For DCI-based beam indication, the first slot to apply the indicated TCI is at least Y symbols after the last symbol of the acknowledgment of the joint or separate DL/UL beam indication. The Y symbols are configured by the network node based on wireless device capability, which is also reported in units of symbols. The values of Y are vet not determined and are left to RAN4 to determine.

### Reference Signal

### Reference Signal Configurations

CSI-RS:

A CSI-RS is transmitted over each transmit (Tx) antenna port at the network node and for different antenna ports. The CSI-RS are multiplexed in time, frequency, and code domain such that the channel between each Tx antenna port at the network node and each receive antenna port at a wireless device may be measured by the wireless device. The time-frequency resource used for transmitting CSI-RS is referred to as a CSI-RS resource.

In NR, the CSI-RS for beam management is defined as a 1- or 2-port CSI-RS resource in a CSI-RS resource set where field repetition is present. The following three types of CSI-RS transmissions are supported:
Periodic CSI-RS: CSI-RS is transmitted periodically in certain slots. This CSI-RS transmission is semi-statically configured using RRC signaling with parameters such as CSI-RS resource, periodicity, and slot offset;
Semi-Persistent CSI-RS: Similar to periodic CSI-RS, resources for semi-persistent CSI-RS transmissions are semi-statically configured using RRC signaling with parameters such as periodicity and slot offset. However, unlike periodic CSI-RS, dynamic signaling is needed to activate and deactivate the CSI-RS transmission;
Aperiodic CSI-RS: This is a one-shot CSI-RS transmission that may happen in any slot. Here, one-shot means that CSI-RS transmission only happens once per trigger. The CSI-RS resources (i.e., the RE locations which consist of subcarrier locations and OFDM symbol locations) for aperiodic CSI-RS are semi-statically configured. The transmission of aperiodic CSI-RS is triggered by dynamic signaling through PDCCH using the CSI request field in UL DCI, in the same DCI where the UL resources for the measurement report are scheduled. Multiple aperiodic CSI-RS resources may be included in a CSI-RS resource set and the triggering of aperiodic CSI-RS is on a resource set basis.
SSB:

In NR, an SSB consists of a pair of synchronization signals (SSs), physical broadcast channel (PBCH), and DMRS for PBCH. An SSB is mapped to 4 consecutive OFDM symbols in the time domain and 240 contiguous subcarriers (20 RBs) in the frequency domain.

To support beamforming and beam-sweeping for SSB transmission, in NR, a cell may transmit multiple SSBs in different narrow-beams in a time multiplexed fashion. The transmission of these SSBs is confined to a half frame time interval (5 ms). It is also possible to configure a cell to transmit multiple SSBs in a single wide beam with multiple repetitions. The design of beamforming parameters for each of the SSBs within a half frame may be based on network implementation. The SSBs within a half frame are broadcasted periodically from each cell. The periodicity of the half frames with SS/PBCH blocks is referred to as SSB periodicity, which is indicated by system information block 1 (SIB1).

The maximum number of SSBs within a half frame, denoted by L, depends on the frequency band, and the time locations for these L candidate SSBs within a half frame depends on the SCS of the SSBs. The L candidate SSBs within a half frame are indexed in an ascending order in time from 0 to L-1. By successfully detecting PBCH and its associated DMRS, a wireless device knows the SSB index. A cell does not necessarily transmit SS/PBCH blocks in all L candidate locations in a half frame, and the resource of the un-used candidate positions may be used for the transmission of data or control signaling instead. It may be up to network implementation to decide which candidate time locations to select for SSB transmission within a half frame, and which beam to use for each SSB transmission.

### Measurement Resource Configurations

In NR, a wireless device may be configured with N≥1 CSI reporting settings (i.e., CSI-ReportConfig), M≥1 resource settings (i.e., CSI-ResourceConfig), where each CSI reporting setting is linked to one or more resource settings for channel and/or interference measurements. The CSI framework is modular, meaning that several CSI reporting settings may be associated with the same Resource Setting.

The measurement resource configurations for beam management are provided to the wireless device by RRC information elements (IEs), CSI-ResourceConfigs. One CSI-ResourceConfig contains several non-zero power (NZP)-CSI-RS-ResourceSets and/or CSI-SSB-ResourceSets.

A wireless device may be configured to perform measurement on CSI-RSs. Here the RRC information element (IE) NZP-CSI-RS-ResourceSet is used. A NZP CSI-RS resource set contains the configuration of Ks≥1 CSI-RS resources, where the configuration of each CSI-RS resource includes at least: mapping to REs, the number of antenna ports, time-domain behavior, etc. Up to 64 CSI-RS resources may be grouped to a NZP-CSI-RS-ResourceSet. A wireless device may also be configured to perform measurements on SSBs. Here, the RRC IE CSI-SSB-ResourceSet is used. Resource sets comprising SSB resources are defined in a similar manner.

In the case of aperiodic CSI-RS and/or aperiodic CSI reporting, the network node configures the wireless device with S_{c} CSI triggering states. Each triggering state contains the aperiodic CSI report setting to be triggered along with the associated aperiodic CSI-RS resource sets.

Periodic and semi-persistent Resource Settings may only include a single resource set (i.e., S=1) while S>=1 for aperiodic Resource Settings. This is because in the aperiodic case, one out of the S resource sets included in the Resource Setting is indicated by the aperiodic triggering state that triggers a CSI report.

### Measurement Reporting

Three types of CSI reporting are supported in NR as follows:
Periodic CSI Reporting on the physical uplink control channel (PUCCH): CSI is reported periodically by a wireless device. Parameters such as periodicity and slot offset are configured semi-statically by higher layer RRC signaling from the network node to the wireless device;
Semi-Persistent CSI Reporting on physical uplink shared channel (PUSCH) or PUCCH: similar to periodic CSI reporting, semi-persistent CSI reporting has a periodicity and slot offset which may be semi-statically configured. However, a dynamic trigger from network node to wireless device may be needed to allow the wireless device to begin semi-persistent CSI reporting. A dynamic trigger from network node to wireless device is needed to request the wireless device to stop the semi-persistent CSI reporting; and
Aperiodic CSI Reporting on PUSCH: This type of CSI reporting involves a single-shot (i.e., one time) CSI report by a wireless device which is dynamically triggered by the network node using DCI. Some of the parameters related to the configuration of the aperiodic CSI report is semi-statically configured by RRC but the triggering is dynamic.

In each CSI reporting setting, the content and time-domain behavior of the report is defined, along with the linkage to the associated Resource Settings. The CSI-ReportConfig IE includes the following configurations:
reportConfigType
   Defines the time-domain behavior, i.e., periodic CSI reporting, semi-persistent CSI reporting, or aperiodic CSI reporting, along with the periodicity and slot offset of the report for periodic CSI reporting;
reportQuantity
   Defines the reported CSI parameter(s) (i.e. the CSI content), such as precoder matrix indicator (PMI), channel quality indicator (CQI), rank indicator (RI), layer indicator (LI), CSI-RS resource index (CRI) and L1-RSRP. Only a certain number of combinations are possible (e.g. ‘cri-RI-PMI-CQI’ is one possible value and ‘cri-RSRP’ is another) and each value of reportQuantity could be said to correspond to a certain CSI mode;
codebookConfig
   Defines the codebook used for PMI reporting, along with possible codebook subset restriction (CBSR). Two “Types” of PMI codebook are defined in NR, Type I CSI and Type II CSI, each codebook type further has two variants each;
reportFrequencyConfiguration
   Define the frequency granularity of PMI and CQI (wideband or subband), if reported, along with the CSI reporting band, which is a subset of subbands of the bandwidth part (BWP) to which the CSI corresponds;
Measurement restriction in time domain (ON/OFF) for channel and interference respectively,

For beam management, a wireless device may be configured to report L1-RSRP for up to four different CSI-RS/SSB resource indicators. The reported RSRP value corresponding to the first (best) CRI/SSBRI requires 7 bits, using absolute values, while the others require 4 bits using encoding relative to the first. In NR 3GPP Rel-16, the report of L1-signal to interference plus noise ratio (SINR) for beam management has already been supported.

### Beam Prediction

One example artificial intelligence/machine learning (AI/ML)-model currently discussed in the Al for air-interface 3GPP Rel-18 includes predicting the channel with respect to a beam for a certain time-frequency resource. The expected performance of such predictor depends on several different aspects, for example time/frequency variation of channel due to wireless device mobility or changes in the environment. Due to the inherit correlation in the time domain, the frequency domain and the spatial domain of the channel, an ML-model may be trained to exploit such correlations. The spatial domain may include different beams, where the correlation properties partly depend on the how the network node antennas form the different beams, and how wireless device forms the receiver beams.

The wireless device may use a prediction ML-model to reduce its measurement related to beamforming. In NR, a network node may request a wireless device to measure on a set of SSB beams or/and CSI-RS beams. A stationary wireless device typically experiences less variations in beam quality in comparison to a moving wireless device. The stationary wireless device may therefore save battery power and reduce the number of beam measurements by using an ML model to predict the beam quality without an explicit measurement. It may do this, for example, by measuring a subset of beams and predicting the rest of the beams. For example, one may with the use of AI measure on a subset of beams in order to predict the best beam, which may reduce the measurement time by up to 75%.

In one existing system, a method is described for enabling a wireless device to predict future beam values based on historical values. Based on received device data from measurement reports, the network node may learn, for example, which sequences of signal quality measurements (e.g., RSRP measurements) lead to large signal quality drop events (e.g., turning around the corners in FIG. 2 which shows two wireless devices moving on similar paths). This learning procedure may be enabled, for example, by dividing periodically reported RSRP data into a training and prediction window.

In the example of FIG. 2, two devices move and turn around the same corner. Wireless device 120b, marked by the dashed line, is the first to turn around the corner and experience a large signal quality drop. The idea is to mitigate the drop of a second wireless device 120a by using learning from the first device's experiences.

The learning may be done by feeding RSRP in t₁, . . . , tₙ into a machine learning model (e.g., neural network), and then learn the RSRP in tₙ₊₁, tₙ₊₂. After the model is trained, the network node may then predict future signal quality values. The signal quality predictions may then be used to avoid radio-link failure, or beam failure, by:
Initiating inter-frequency handover;
Setting handover/reselection parameters;
Pre-emptively performing candidate beam selection to avoid beam failure; and
Changing device scheduler priority, for example schedule device when the expected signal quality is good.

### Agreements RAN1#109-e

During the 3GPP meeting RAN1#109-e, it was considered to study AI/ML based temporal beam prediction for a set A of beams based on measurement results of Set B of beams, where the Set A of beams and Set B of beams may be the same set of beams or different set of beams. It was also discussed that the measurement results of K (K>=1) latest measurement instances during a time window TI of the Set B beams are used for AI/ML model input. Furthermore, it was discussed that one or more beams from the Set A beams may be used as AI/ML model output, where the AI/ML model output may be F predictions for F future time instances, where all F future time instances are located within a time window T2.

It has been considered in 3GPP that K measurement instances of a Set B beams may be used as input for the beam prediction AI/ML model to predict one or more beams from a set A beam for F number of future time instance. However, it has not been discussed how these beam predictions are meant to be used.

In the existing system, reports including information about the beam quality (e.g., CSI reports including CSI measurements for beam management procedures, such as SS-RSRP, L1 RSRP of one or more SSB indices) are typically responded to with a MAC CE (or DCI) indicating one or more TCI states of a Serving Cell (typically associated to one of the reported beams) to be updated (activated and/or deactivated) and/or a MAC CE (or DCI) indicating CSI measurement configuration(s), such as CSI reporting configuration(s), to be updated (activated/deactivated).

However, beam reporting may be transmitted when the quality of current beam is lower than acceptable and another beam has much better quality, so that the reception of the MAC CE to update the beam occurs in a beam with poor quality (which is still the beam the wireless device is monitoring). That may lead to the need for retransmissions, which may delay the wireless device reception of the command, and/or the wireless device not properly receiving the command, which may lead to Beam Failure Detection (BFD) and/or Radio Link Failure (RLF). In addition to this problem, even if radio conditions are acceptable upon reception of MAC CEs for updating TCI state(s), there is still a significant amount of signaling in terms of reports and responses from the network node, which represents both an overhead in the air interface and energy consumption at the wireless device for receiving the command in response to a report.

### SUMMARY

Some embodiments advantageously provide methods, network node and wireless devices for beam indications for wireless device (WD)-sided time domain beam predictions.

One or more embodiments described herein describe a method at a wireless device for updating one or more beams that the wireless device uses for monitoring channel(s) in a network node, the method including:
receiving an indication from the network node for autonomously updating one of its configured beams at one or more determined time occasions after the reception of the indication;
updating the one of its configured beams at the one or more determined time occasions.

In one or more embodiments, the method includes the wireless device receiving the indication in response to a report transmitted by the wireless device, wherein the report includes predicted information on the one or more configured beams for determined time occasions.

One or more embodiments also describe a method at network function/node (e.g., gNodeB) for updating one or more beams the wireless device uses for monitoring channel(s) in a network, the method includes:
transmitting an indication to a wireless device for autonomously updating one of the wireless device's configured beams at one or more determined time occasions after the transmission of the indication;
Updating the wireless device's configured beams at the one or more determined time occasions.

In one or more embodiments, the method includes the network/network node transmitting the indication to the wireless device in response to a report received from the wireless device, where the report includes predicted information on the one or more configured beams for determined time occasions.

According to one aspect, a wireless device, WD, configured to communicate with a network node is provided. The WD is configured to receive from the network node a channel state information, CSI, reporting configuration indicating a first set of future time instances for CSI predictions to be reported by the WD to the network node. The WD is configured to perform a time sequence of measurements on a set of reference signal beams transmitted by the network node. The WD is also configured to transmit to the network node a beam information report that includes CSI predictions the first set of future time instances, the CSI predictions based at least in part on the time sequence of measurements. The WD is further configured to receive from the network node a beam indication indicating at least one selected beam for the CSI predictions to be autonomously applied by the WD at a second set of future time instances.

According to this aspect, in some embodiments, the beam indication indicates the second set of future time instances at which the at least one selected beam is to be autonomously applied by the WD. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD.

According to another aspect, a method is provided in a wireless device, WD, configured to communicate with a network node. The method includes receiving from the network node a channel state information, CSI, reporting configuration indicating a first set of future time instances for CSI predictions to be reported by the WD to the network node. The method also includes performing a time sequence of measurements on a set of reference signal beams transmitted by the network node. The method includes transmitting to the network node a beam information report that includes CSI predictions the first set of future time instances, the CSI predictions based at least in part on the time sequence of measurements. The method further includes receiving from the network node a beam indication indicating at least one selected beam for the CSI predictions to be autonomously applied by the WD at a second set of future time instances.

According to this aspect, in some embodiments, the beam indication indicates the second set of future time instances at which the at least one selected beam is to be autonomously applied by the WD. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD.

According to yet another aspect, a network node configured to communicate with a wireless device, WD, is provided. The network node is configured to transmit to the WD a channel state information, CSI, reporting configuration indicating a first set of future time instances for CSI predictions to be reported by the WD to the network node. The network node is also configured to receive from the WD, a beam information report including indications of CSI predictions at the first set of future time instances based at least in part on a time sequence of measurements on a set of reference signal beams. The network node is further configured to transmit to the WD a beam indication for at least one selected beam for the CSI predictions to be autonomously applied by the WD at a second set of future time instances.

According to this aspect, in some embodiments, the beam indication indicates the second set of future time instances at which the at least one selected beam is to be autonomously applied by the WD. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD.

According to another aspect, a method in a network node configured to communicate with a wireless device, WD, is provided. The method includes transmitting to the WD a channel state information, CSI, reporting configuration indicating a first set of future time instances for CSI predictions to be reported by the WD to the network node. The method includes receiving from the WD, a beam information report including indications of CSI predictions at the first set of future time instances based at least in part on a time sequence of measurements on a set of reference signal beams. The method includes transmitting a beam indication for at least one selected beam for the CSI predictions to be autonomously applied by the WD at a second set of future time instances.

According to this aspect, in some embodiments, the beam indication indicates the second set of future time instances at which the at least one selected beam is to be autonomously applied by the WD. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an example beam management procedure;

FIG. 2 is an example of two devices moving in similar paths;

FIG. 3 is a schematic diagram of an exemplary network architecture illustrating a communication system connected via an intermediate network to a host computer according to the principles in the present disclosure;

FIG. 4 is a block diagram of a host computer communicating via a network node with a wireless device over an at least partially wireless connection according to some embodiments of the present disclosure;

FIG. 5 is a flowchart illustrating exemplary methods implemented in a communication system including a host computer, a network node and a wireless device for executing a client application at a wireless device according to some embodiments of the present disclosure;

FIG. 6 is a flowchart illustrating exemplary methods implemented in a communication system including a host computer, a network node and a wireless device for receiving user data at a wireless device according to some embodiments of the present disclosure;

FIG. 7 is a flowchart illustrating exemplary methods implemented in a communication system including a host computer, a network node and a wireless device for receiving user data from the wireless device at a host computer according to some embodiments of the present disclosure;

FIG. 8 is a flowchart illustrating exemplary methods implemented in a communication system including a host computer, a network node and a wireless device for receiving user data at a host computer according to some embodiments of the present disclosure;

FIG. 9 is a flowchart of an exemplary process in a network node according to some embodiments of the present disclosure;

FIG. 10 is a flowchart of an exemplary process in a wireless device according to some embodiments of the present disclosure;

FIG. 11 is a flowchart of an exemplary process in a network node according to some embodiments of the present disclosure;

FIG. 12 is a flowchart of an exemplary process in a wireless device according to some embodiments of the present disclosure;

FIG. 13 is an example diagram of a schematic example of set A and set b of beams where set A and set B are different;

FIG. 14 is an example diagram of a schematic example of set A and set b of beams where set A and set B are the same;

FIG. 15 is an example of an embodiment where a single message indicates which beam to apply for each of the reported future time instances;

FIG. 16 is an of an embodiment where separate messages are used to indicate which beam to apply for each of the reported future time instances;

FIG. 17 is an embodiment where the wireless device automatically activates the reported beams in the beam prediction report, and then beam indications with DCI may be used to indicate which beam to apply at which time;

FIG. 18 is an example flowchart of processes in the network node and wireless device according to some embodiments of the present disclosure;

FIG. 19 is an example diagram of TCI states activation/deactivation for WD-specific PDSCH MAC CE;

FIG. 20 is an example of enhanced TCI states activation/deactivation for WD-specific PDSCH MAC CE; and

FIG. 21 is an example of enhanced TCI states activation/deactivation for WD-specific PDSCH MAC CE with additional modifications.

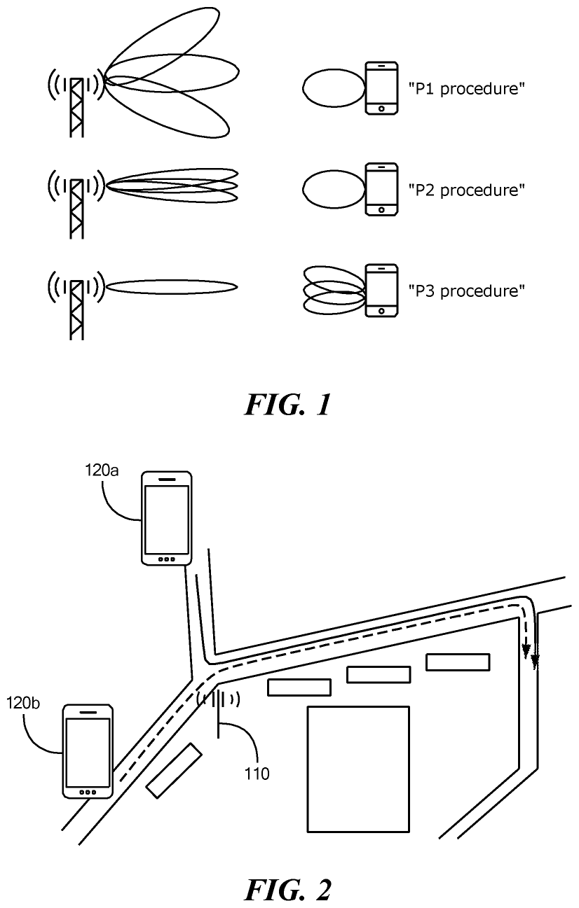

### DETAILED DESCRIPTION

Before describing in detail exemplary embodiments, it is noted that the embodiments reside primarily in combinations of apparatus components and processing steps related to beam indications for wireless device (WD)-sided time domain beam predictions. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising.” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node included in a radio network which may further include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also include test equipment. The term “radio node” used herein may be used to also denote a wireless device (WD).

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrow band IoT (NB-IOT) device, etc.

Also, in some embodiments the generic term “radio network node” is used. It may be any kind of a radio network node which may include any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

In one or more embodiments, a “configured beam” is a beam the wireless device is configured with and may correspond to one of the “configured TCI State(s)” the wireless device is configured with upon reception of an RRC message (such as an RRC Reconfiguration when the wireless device enters RRC_CONNECTED or when the wireless device is in RRC_CONNECTED and/or an RRC Resume received when the wireless device transitions from RRC_INACTIVE to RRC_CONNECTED). The wireless device may be configured with one or more TCI states, such as instances of the IE TCI-State, where each instance is associated with at least one Downlink (DL) Reference Signal (RS) with a corresponding quasi-colocation (QCL) type, such as type D, e.g., indicating that a TCI state corresponds to a spatial direction and/or a DL beam in which the configured DL RS is transmitted.

In one or more embodiments, a “beam” may also correspond to a spatial direction in which a DL RS is being transmitted by the network node and in which a control channel, such as a Physical DL Control Channel (PDCCH) and/or a data channel, such as Physical DL Shared Channel (PDSCH).

The term “autonomously” in the context of one or more embodiments means that the wireless device does not perform the update upon reception of the indication, but at a future time instance, in an autonomous manner.

In one or more embodiments, a time domain beam prediction (TDBP) or a temporal beam prediction (TBP) AI/ML model may be viewed as a functionality or part of a functionality that is related to time domain beam prediction and is deployed/implemented/configured/defined in a wireless device.

A TDBP/TBP AI/ML model may be defined as a feature, or part of a feature, that is implemented/supported in a wireless device, and the wireless device may indicate the feature version to another network node (e.g., a gNB). If the AI/ML model is updated, the feature version may be changed by the wireless device. The AI/ML model is understood to be any trainable ML algorithm including but not limited to, for example, artificial neural networks, decision trees, random forests, nearest neighbors, and support vector machines.

An TDBP/TBP AI/ML-model may correspond to a function that receives one or more inputs (e.g., channel measurements on a set B of beams) at time instances within T1 and outputs one-or-more decisions, estimates, or prediction(s) of a certain type (e.g., CSI for a set A of beams, or top-K predicted beams from set A of beams) at time instances within T2.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

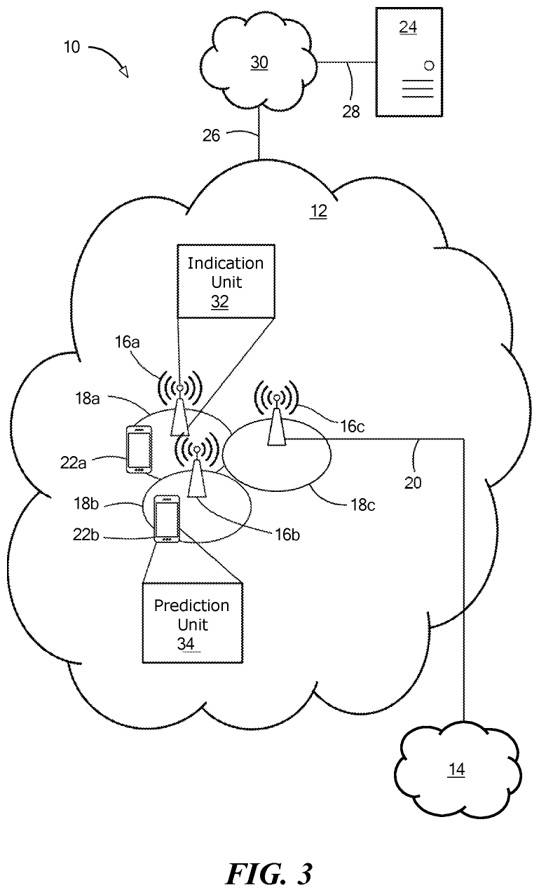

Some embodiments provide beam indications for wireless device (WD)-sided time domain beam predictions. Referring again to the drawing figures, in which like elements are referred to by like reference numerals, there is shown in FIG. 3 a schematic diagram of a communication system 10, according to an embodiment, such as a 3GPP-type cellular network that may support standards such as LTE and/or NR (5G), which includes an access network 12, such as a radio access network, and a core network 14. The access network 12 includes a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may include two or more sub-networks (not shown).

The communication system of FIG. 3 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include an indication unit 32 which may be configured to cause transmission to the WD of a beam indication for at least one selected beam for the CSI predictions to be autonomously applied by the WD at a second set of future time instances. A wireless device 22 is configured to include a prediction unit 34 which may be configured to cause transmission to the network node of a beam information report that includes CSI predictions for the first set of future time instances, the CSI predictions based at least in part on the time sequence of measurements.

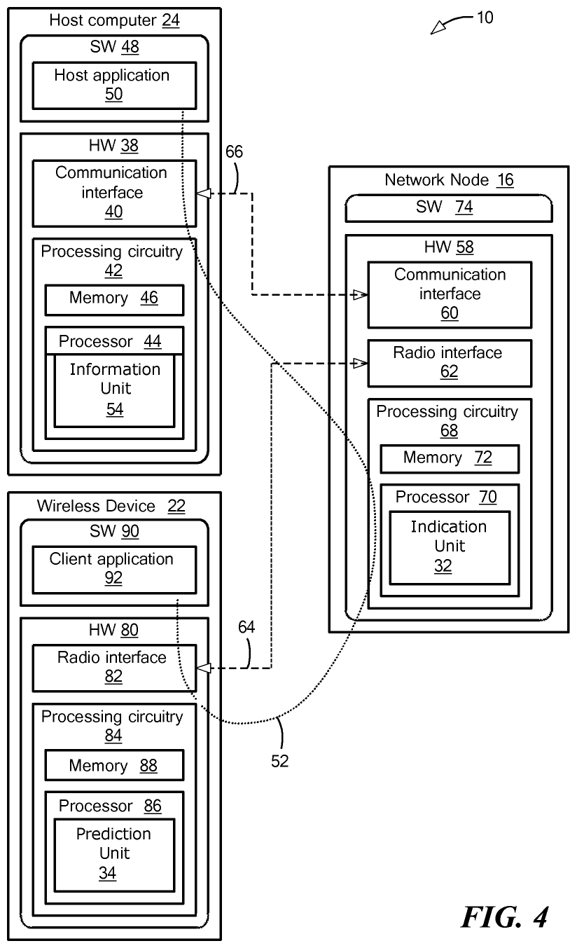

Example implementations, in accordance with an embodiment, of the WD 22. network node 16 and host computer 24 discussed in the preceding paragraphs will now be described with reference to FIG. 4. In a communication system 10, a host computer 24 includes hardware (HW) 38 including a communication interface 40 configured to set up and maintain a wired or wireless connection with an interface of a different communication device of the communication system 10. The host computer 24 further includes processing circuitry 42, which may have storage and/or processing capabilities. The processing circuitry 42 may include a processor 44 and memory 46. In particular, in addition to or instead of a processor, such as a central processing unit, and memory, the processing circuitry 42 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In some embodiments, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include an information unit 54 configured to enable the service provider to one or more of store, process, forward, relay, transmit, receive, communicate, evaluate, predict, etc. information described herein such as information related to, for example, beam prediction for future time instances.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60) may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include an indication unit 32 which may be configured to cause transmission to the WD of a beam indication for at least one selected beam for the CSI predictions to be autonomously applied by the WD at a second set of future time instances.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may include integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may include any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further include software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a prediction unit 34 which may be configured to cause transmission to the network node of a beam information report that includes CSI predictions for the first set of future time instances, the CSI predictions based at least in part on the time sequence of measurements.

In some embodiments, the inner workings of the network node 16, WD 22, and host computer 24 may be as shown in FIG. 4 and independently, the surrounding network topology may be that of FIG. 3.

In FIG. 4, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16.

Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or includes a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 3 and 4 show various “units” such as indication unit 32, and prediction unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

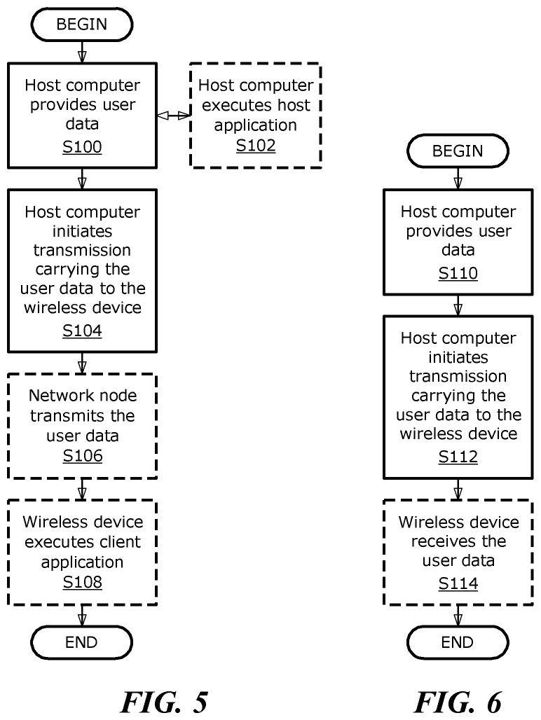

FIG. 5 is a flowchart illustrating an exemplary method implemented in a communication system, such as, for example, the communication system of FIGS. 3 and 4, in accordance with one embodiment. The communication system may include a host computer 24, a network node 16 and a WD 22, which may be those described with reference to FIG. 4. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 6 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

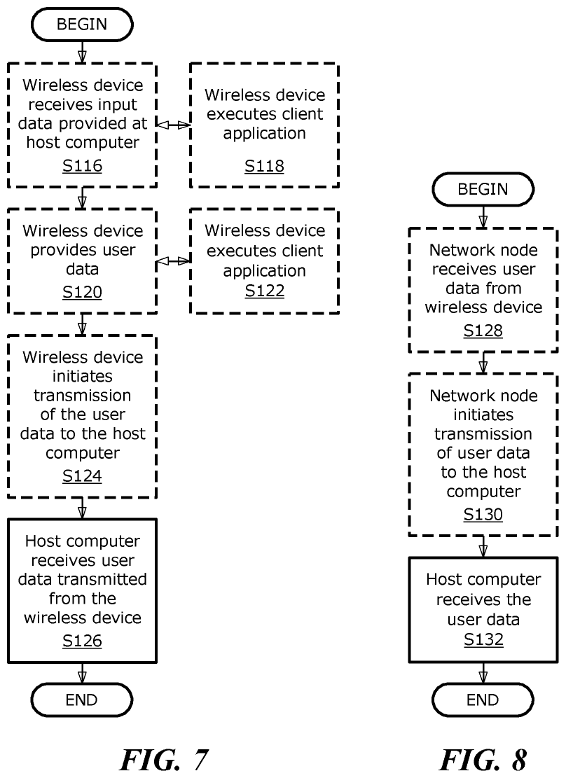

FIG. 7 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 24, a network node 16 and a WD 22, which may be those described with reference to FIGS. 3 and 4. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

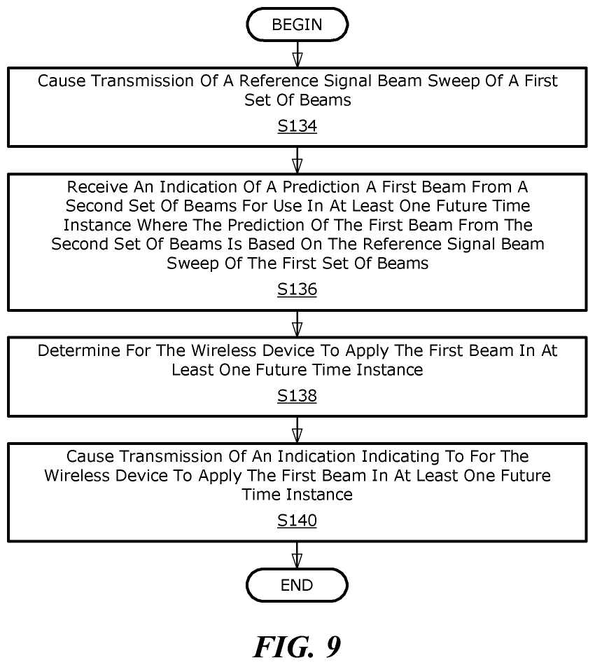

FIG. 9 is a flowchart of an exemplary process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to cause (Block S134) transmission of a reference signal beam sweep of a first set of beams, as described herein. Network node 16 is configured to receive (Block S136) an indication of a prediction a first beam from a second set of beams for use in at least one future time instance where the prediction of the first beam from the second set of beams is based on the reference signal beam sweep of the first set of beams, as described herein. Network node 16 is configured to determine (Block S138) for the wireless device to apply the first beam in at least one future time instance, as described herein. Network node 16 is configured to cause (Block S140) transmission of an indication indicating to for the wireless device to apply the first beam in at least one future time instance, as described herein.

According to one or more embodiments, the applying of the first beam in at least one future time instance occurs without causing transmission of a medium access control, MAC, control element, CE, and downlink control information, DCI, associated with the first beam in the at least one future time instance. According to one or more embodiments, the reference signal is a channel state information-reference signal, CSI-RS. According to one or more embodiments, the indication corresponds to at least one transmission configuration indication, TCI, state being activated for the at least one future time instance.

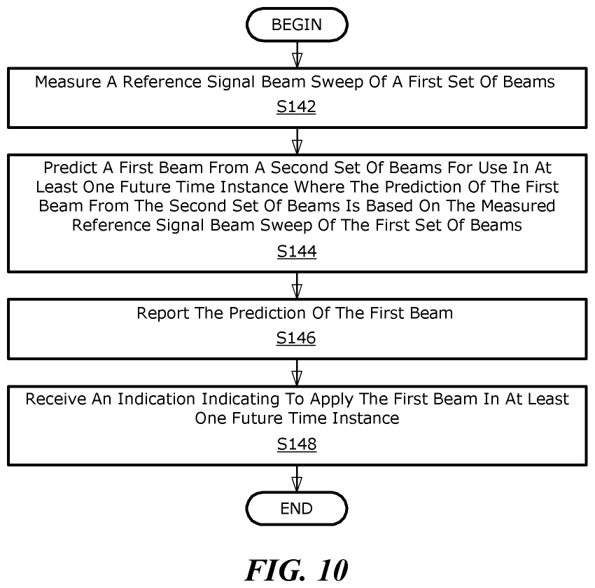

FIG. 10 is a flowchart of an exemplary process in a wireless device 22 according to some embodiments of the present disclosure. One or more blocks described herein may be performed by one or more elements of wireless device 22 such as by one or more of processing circuitry 84 (including the prediction unit 34), processor 86, radio interface 82 and/or communication interface 60. Wireless device 22 is configured to measure (Block S142) a reference signal beam sweep of a first set of beams, as described herein. Wireless device 22 is configured to predict (Block S144) a first beam from a second set of beams for use in at least one future time instance where the prediction of the first beam from the second set of beams is based on the measured reference signal beam sweep of the first set of beams, as described herein. Wireless device 22 is configured to report (Block S146) the prediction of the first beam, as described herein. Wireless device 22 is configured to receive (Block S148) an indication indicating to apply the first beam in at least one future time instance, as described herein.

According to one or more embodiments, the applying of the first beam in at least one future time instance occurs without receiving a medium access control, MAC, control element, CE, and downlink control information, DCI, associated with the first beam in the at least one future time instance. According to one or more embodiments, the reference signal is a channel state information-reference signal, CSI-RS. According to one or more embodiments, the indication corresponds to at least one transmission configuration indication, TCI, state being activated for the at least one future time instance.

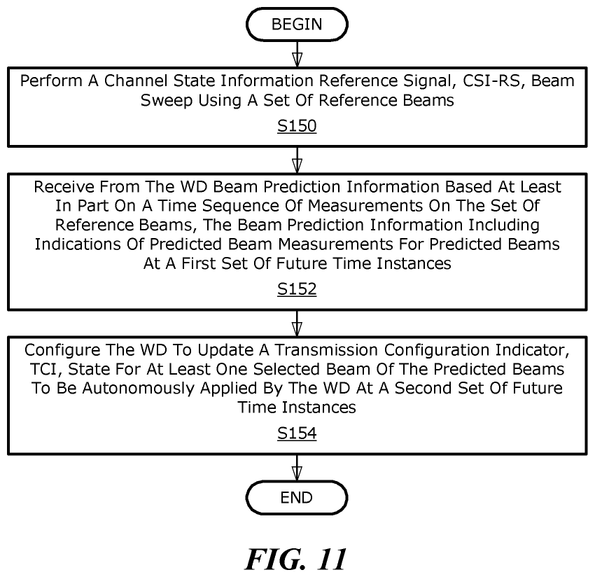

FIG. 11 is a flowchart of an exemplary process in a network node 16 according to some embodiments of the present disclosure. One or more blocks described herein may be performed by one or more elements of network node 16 such as by one or more of processing circuitry 68 (including the indication unit 32), processor 70, radio interface 62 and/or communication interface 60. Network node 16 is configured to transmit (Block S150) to the WD 22 a channel state information, CSI, reporting configuration indicating a first set of future time instances for CSI predictions to be reported by the WD 22 to the network node 16. The method includes receiving (Block S152) from the WD 22, a beam information report including indications of CSI predictions at the first set of future time instances based at least in part on a time sequence of measurements on a set of reference signal beams. The method includes transmitting (Block S154) a beam indication for at least one selected beam for the CSI predictions to be autonomously applied by the WD 22 at a second set of future time instances.

In some embodiments, the beam indication indicates the second set of future time instances at which the at least one selected beam is to be autonomously applied by the WD 22. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD 22 is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD 22.

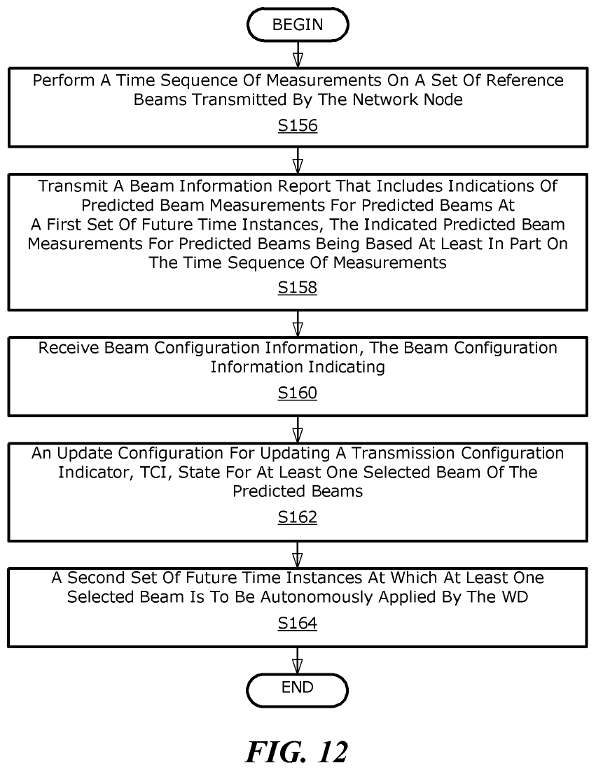

FIG. 12 is a flowchart of an exemplary process in a wireless device 22 according to some embodiments of the present disclosure. One or more blocks described herein may be performed by one or more elements of wireless device 22 such as by one or more of processing circuitry 84 (including the prediction unit 34), processor 86, radio interface 82 and/or communication interface 60. Wireless device 22 is configured to receiving (Block S156) from the network node 16 a channel state information, CSI, reporting configuration indicating a first set of future time instances for CSI predictions to be reported by the WD 22 to the network node 16. The method also includes performing (Block S158) a time sequence of measurements on a set of reference signal beams transmitted by the network node 16. The method includes transmitting (Block S160) to the network node 16 a beam information report that includes CSI predictions the first set of future time instances, the CSI predictions based at least in part on the time sequence of measurements. The method further includes receiving (Block S162) from the network node 16 a beam indication indicating at least one selected beam for the CSI predictions to be autonomously applied by the WD 22 at a second set of future time instances.

In some embodiments, the beam indication indicates the second set of future time instances at which the at least one selected beam is to be autonomously applied by the WD 22. In some embodiments, the beam indication indicates a first subset of the second set of future time instances for which a first selected beam is to be autonomously applied and indicates a second subset of the second set of future time instances for which a second selected beam is to be autonomously applied. In some embodiments, beams of the set of reference signal beams are a subset of a set of beams for which the CSI predictions are selected. In some embodiments, the beam indication indicates whether the WD 22 is to activate a transmission configuration indicator, TCI, state at a time instance of the second set of future time instances. In some embodiments, the beam indication indicates which one of a plurality of selected beams is to be applied at each time instance of the second set of future time instances. In some embodiments, the first set of future time instances are equally distributed in time. In some embodiments, a first subset of the first set of future time instances is separated from a second subset of the first set of future time instances by a gap. In some embodiments, the beam information report includes an instantaneous beam report. In some embodiments, the second set of future time instances is determined by the WD 22.

Having described the general process flow of arrangements of the disclosure and having provided examples of hardware and software arrangements for implementing the processes and functions of the disclosure, the sections below provide details and examples of arrangements for beam indications for wireless device (WD)-sided time domain beam predictions.

Some embodiments provide beam prediction for future time instances. One or more wireless device 22 functions described below may be performed by one or more of processing circuitry 84, processor 86, prediction unit 34, etc. One or more network node 16 functions described below may be performed by one or more of processing circuitry 68, processor 70, indication unit 32, etc.

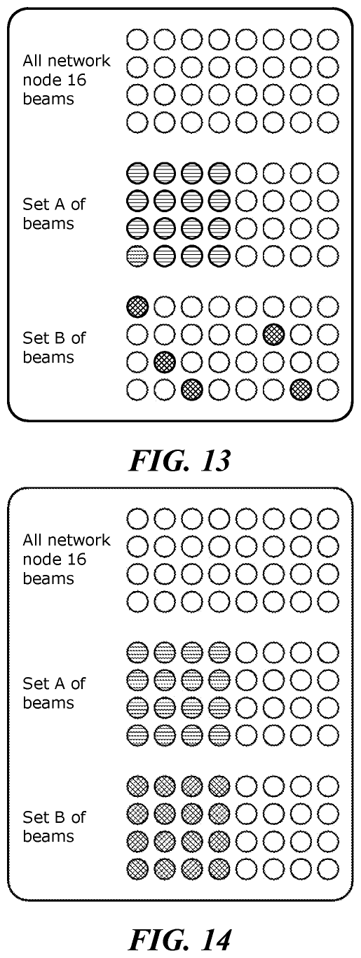

FIGS. 13 and 14 are diagrams of schematic examples of the Set A of beams and the Set B of beams, as described herein. In FIG. 13, the Set A of beams are different than Set B of beams, and in FIG. 14, the Set A of beams are the same as Set B of beams. The Set A and/or Set B of beams may consist of all the network node beams or a subset of them.

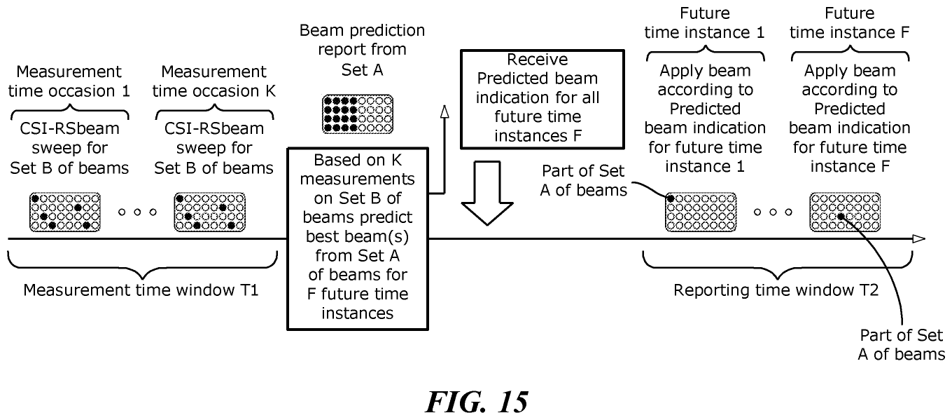

FIGS. 15 to 17 illustrate example of three different embodiments according to the teachings of the present disclosure. In a first step of FIGS. 15-17, the network node 16 transmits a CSI-RS beam sweep using the Set B of beams K times during a time window T1. Based on the measurements of the K beam sweeps, the wireless device 22 tries/attempts to predict or predicts the best beam from the set A of beams for F future time instances and reports the prediction of the best beam to the network node 16. In the next step (and one aspect of the present disclosure) the network node 16 indicates which TCI state the wireless device 22 should activate and when).

In FIG. 15, the network or network node 16 signals the beam indication for all reported future time instances in a single message, e.g., a DCI or a MAC-CE. The wireless device 22 then applies the corresponding TCI states during each future time instance according to that beam indication. The message may for example contain a single bitfield that indicates that the wireless device 22 should follow the reported predicted beams for respective future time instance or not follow any of them. In one or more embodiments, a more detailed beam indication may be used, where for example a certain reported predicted beam is indicated for each future time instance. This may be used, for example, in case multiple predicted beams are reported for each future time instance.

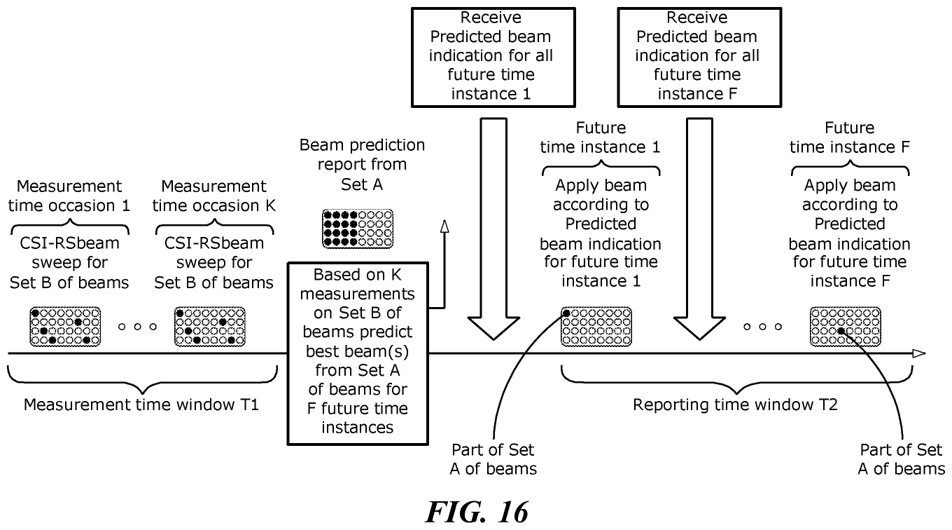

In FIG. 16, the network or network node 16 signals the beam indication for each future time instance using multiple different messages (for example different DCIs or MAC-CEs). The association between a message and a future time instance could for example be based on the timing of a DCI. For example, assume that the wireless device 22 has reported predicted beams for future time instances T1+delta_t, T1+2*delta_t, and T1+3*delta_t, and that the network node 16 decides to not apply the reported predicted beam for future time instance T1*delta_t and T1+2*delta_t, but decides to apply the reported predicted beam for T1+3*delta_t. In this case the network/network node 16 may transmit a DCI between T1+2*delta_t and T1+3*delta_t, and only use 1 bit to indicate whether the wireless device 22 should follow the predicted beam or not for T1+3*delta_t. Since the wireless device 22 doesn't receive a beam switch indication before T1+2*delta_t, the wireless device 22 will not perform a TCI state update for T1+delta_t and T1+2*delta_t. This solution may be used to reduce the DCI overhead for the same beam update flexibility compared to the embodiment in FIG. 15.

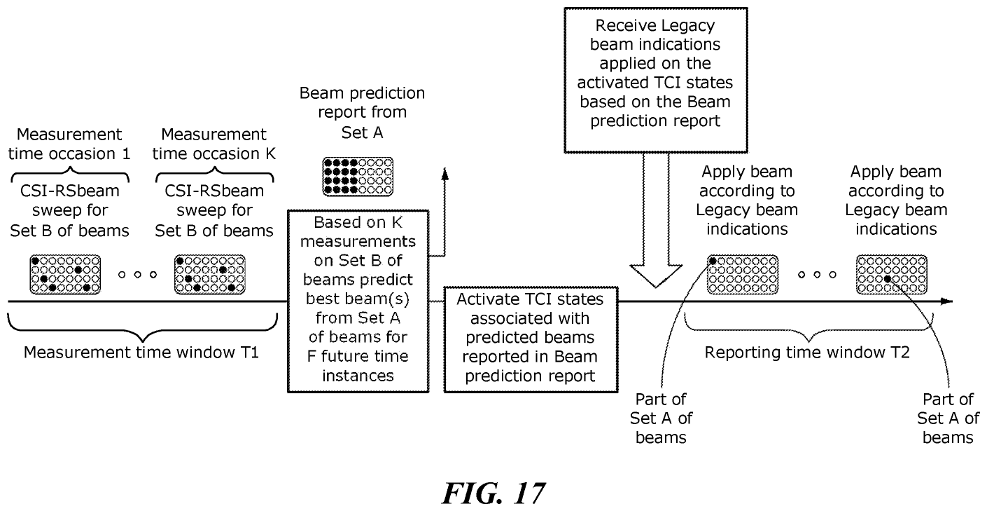

In FIG. 17, the wireless device 22 activates the TCI states associated with all or a subset of all reported beams in the beam prediction report. In this way, the network/network node 16 may directly apply DCI based TCI state switching on the predicted beams without a previous intermediate step of activating the TCI states with MAC-CE, which would introduce extra overhead and latency. The actual beam indication may then be performed with, for example, the NR legacy beam indication by using the TCI field in DCI format 1_1 or a new similar beam indication in 6G.

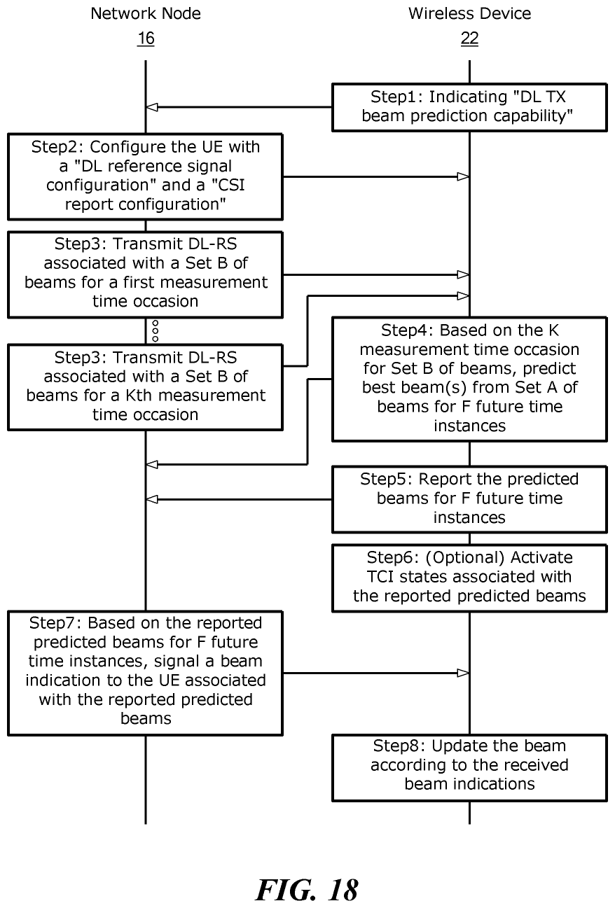

FIG. 18 is a flowchart of an example method in accordance with the principles of the present disclosure. In Step 1 the wireless device 22 reports, for example, during wireless device 22 capability signaling, support of receiving beam indications based on reported beam predictions from a Set A of network node 16 beams for F future time instances based on K measurements on a Set B of network node 16 beams. The wireless device 22 capability signaling (“DL Tx beam prediction capability”) may, for example, include one or more of the following:
Support of DCI based beam indication;
Support of MAC-CE based beam indication; and/or
Support of automatic TCI state activation based on reported predicted beams. In Step2, the network node 16 indicates the relevant configurations for the time domain beam prediction, for example a “DL reference signal configuration”, or a “CSI report configuration”. The “DL reference signal configuration” may for example consist of one or more of:
   Resource Setting (i.e., CSI-ResourceConfig as specified in, for example, 3GPP Technical Standard (TS) 38.311);
   CSI-RS resource sets (i.e., NZP-CSI-RS-ResourceSet as specified in, for example, 3GPP TS 38.311);
   CSI-RS resources (i.e., NZP-CSI-RS-Resource as specified in, for example, 3GPP TS 38.311); and/or
   New potential DL-RS resource configuration for 6G.
      The “CSI report configuration” may for example consist of one or more of:
Report Setting (i.e. CSI-ReportConfig as specified in, for example, 3GPP TS 38.311); and/or
A new potential CSI measurement/report configuration for 6G.

In Step 3, the network node 16 performs K Set B beam sweeps by transmitting a set of DL reference signals associated with the Set B of beams at K different times.

In Step 4, the wireless device 22 predicts the best Y beams from Set A of beams for F future time instances based on measurements from the K Set B beam sweeps.

In Step 5 the wireless device 22 reports the predicted beams to the network node 16.

Optionally, in some embodiments, the wireless device 22 activates TCI states associated with the predicted reported beams. See Optional Step 6. In this way, legacy DCI based beam indications may be applied directly to the reported predicted beams without an intermediate step of activating the TCI state with a DL MAC-CE.

In Step 7, the network node 16 signals beam indications to the wireless device 22. The beam indication signaling may carry a single message containing a beam indication for all reported future time instances, or separate messages for respective reported future time instances.

In Step 8, the wireless device 22 updates the beam according to the received beam indication(s).

In some embodiments, the indication configures the wireless device 22 to autonomously update one or more of its configured beams in one or more future time occasion(s) denoted t1, t1+T′, t1+2T′, . . . , t1+(F−1)T′, wherein “updating” includes activating, deactivation, adding, removing or suspending a configured beam and/or TCI state associated to a beam index and/or DL RS configured as QCL source and/or a CSI measurement configuration (e.g. a reporting configuration).

In some embodiments, the indication configures the wireless device 22 to update: beam index X1 in future time occasion t1, beam index X2 in future time occasion t1+T′, beam index X3 in future time occasion t1+2T′, . . . beam index X_{F} in future time occasion t1+(F−1)T′, wherein the indication is received at t0 (which is before t1). Thus, at t1, the wireless device 22 autonomously updates beam index X1, at t1+T′ the wireless device 22 updates beam index X2, at t1+2T′ the wireless device 22 updates beam index X3, . . . , and at t1+(F−1)T′ the wireless device 22 updates beam index X_{F}.

In some embodiments, the indication configures the wireless device 22 to update: TCI state ID=X1 in future time occasion t1, TCI state ID=X2 in future time occasion t1+T′, TCI state ID=X3 in future time occasion t1+2T′ . . . . TCI state ID=X_{F} in future time occasion t1+(F−1)T′, where the indication is received at t0 (which is before t1). Thus, at t1, the wireless device 22 autonomously update TCI state ID=X1, at t1+T′ the wireless device 22 updates TCI state ID=X2, at t1+2T′ the wireless device 22 updates TCI state ID=X3 . . . , and at t1+(F−1)T′ the wireless device 22 updates TCI state ID=X_{F}.

In some embodiments, when the indication configures the wireless device 22 to autonomously activate one or more of its configured TCI states in one or more future time occasion(s) denoted t1, t1+T′, t1+2T′, . . . , t1+(F−1)T′, then at each future time occasion the wireless device 22 activates the indicated TCI state, and deactivates a currently activated TCI state at that respective time occasion.

In some embodiments, the indication is transmitted by the network node 16 assuming that the network node 16 is deployed with a function which is capable of performing one or more time-domain predictions for DL RSs and/or beams transmitted to a wireless device 22. For example, the network node 16 may predict at a time to that the wireless device 22 is going to be served as follows: beam index X1 in future time occasion t1, beam index X2 in future time occasion t1+T′, beam index X3 in future time occasion t1+2T′, . . . , beam index XF in future time occasion t1+(F−1) T′. Then, instead of waiting for CSI reports from the wireless device 22 indicating beam quality (L1 RSRP for one or more SSB indices and/or CSI-RS resource identities), the network node 16 proactively transmits the indication as described herein to the wireless device 22, indicating that at t1, the wireless device 22 may autonomously update beam index X1, at t1+T′ the wireless device 22 may update beam index X2, at t1+2T′ the wireless device 22 may update beam index X3, . . . , and at t1+(F−1)T′ the wireless device 22 may update beam index X_{F}.

In some embodiments, the indication is received by the wireless device 22 in response to (or after) the transmission of a report from the wireless device 22 including predicted information of one or more beam(s).

In some embodiments the one or more beams are beams the wireless device 22 selects out of a set of beams. The one or more selected beams may be a subset of a configured set of beams (set A) to be predicted and/or measured.

In some embodiments, the predicted information is derived based on one or more time-domain prediction(s) of CSI measurements, where a time-domain prediction may correspond to the prediction of an SS-RSRP and/or L1 RSRP value (for an SSB) on one or more DL RSs/beams, e.g., based on an AI/ML model deployed at the wireless device 22. Other examples of time-domain predictions are predicted SS-reference signal received quality (RSRQ) and/or L1 RSRQ for SSBs, SS-SINR, CSI-RSRP, CSI-RSRQ, CSI-SINR.

In some embodiments, the predicted information includes a beam identifier (and/or DL RS index, SSB index, CSI-resource element (RE) resource identity) of a selected beam (DL RS, SSB index, CSI-RS resource identity), corresponding to a “best” beam in a future time occasion. The best beam may be determined according to one or more criteria. The best beam may be a beam transmitted in a spatial direction and may correspond to a DL RS transmitted in a spatial direction and/or may also correspond to a TCI state having QCL source configuration corresponding to a DL RS transmitted in a spatial direction.

In some embodiments, the selected beam or the “best” beam is the beam the wireless device 22 selects based on measurements of the associated DL RS. For example, using an RSRP measurements (SS-RSRP, in the case of an SSB, or DL RS RSRP), the WD 22 may select a beam prediction resulting in a highest RSRP, for example, in a future time occasion.

The wireless device 22 may report a selected beam for each future time occasion (wherein each future time occasion is pre-determined and/or configured), such as:
beam index X1 for future time occasion t1;
beam index X2 for future time occasion t1+T″;
beam index X3 for future time occasion t1+2T′;
. . .
beam index X_{F} for future time occasion t1+(F−1)T′.

The wireless device 22 may report a selected DL RS for each future time occasion (where each future time occasion is pre-determined and/or configured). For example: DL RS index X1 for future time occasion t1, DL RS index X2 for future time occasion t1+T ′, DL RS index X3 for future time occasion t1+2T′, . . . , DL RS index X_{F} for future time occasion t1+(F−1)T′.

The wireless device 22 may report a selected SSB for each future time occasion (wherein each future time occasion is pre-determined and/or configured), such as: SSB index X1 for future time occasion t1, SSB index X2 for future time occasion t1+T′, SSB index X3 for future time occasion t1+2T′, . . . , SSB XF for future time occasion t1+(F−1)T′

The wireless device 22 may report a selected CSI-RS for each future time occasion (where each future time occasion is pre-determined and/or configured), such as: CSI-RS resource identifier index X1 for future time occasion t1, CSI-RS resource identifier X2 for future time occasion t1+T′, CSI-RS resource identifier X3 for future time occasion t1+2T′, . . . , CSI-RS resource identifier XF for future time occasion t1+(F−1)T′

The wireless device 22 may report a selected TCI state for each future time occasion (wherein each future time occasion is pre-determined and/or configured), such as: TCI state ID X1 for future time occasion t1, TCI State ID X2 for future time occasion t1+T′, TCI State ID X3 for future time occasion t1+2T′, . . . , TCI State ID X_{F} for future time occasion t1+(F−1)T′

When the one or more beams are beams of a serving cell, the wireless device 22 is configured with, e.g., the Pcell, an Scell of the Master Cell Group (MCG), the PSCell, or an Scell of the Secondary Cell Group (SCG).

In some embodiments, the indication the wireless device 22 receives indicates to the wireless device 22 that the one or more beams included in the report are to be updated by the wireless device 22 autonomously at the respective future time occasions.

In some embodiments, the indication includes a command, such as a DL Control Indication (DCI) or a Medium Access Control layer (MAC) Control Element (CE) from the network node 16 acknowledging the selection from the wireless device 22. For example, if the wireless device 22 reported the following: SSB index X1 for future time occasion t1, SSB index X2 for future time occasion t1+T′, SSB index X3 for future time occasion t1+2T′, . . . , SSB XF for future time occasion t1+(F−1)T′; and the network node 16 acknowledges the report, then the wireless devices 22 updates its spatial filter used to transmit and/or receive signals.

In some embodiments, the indication includes an identifier associated to the report the wireless device 22 has transmitted so that upon receiving the indication the wireless device 22 knows the indication is acknowledging a transmitted report. The identifier in the indication may be the reporting configuration identifier (e.g., an integer) associated to the report, which was configured in the reporting configuration.

In some embodiments, the indication includes an indication of the physical channel (or physical channels, if multiple) associated to the TCI state(s) which are to be updated in the future time occasions. The physical channel indicated may be, e.g., PDCCH, PDSCH, PUCCH, PUSCH, random access channel (RACH), etc.

In some embodiments, the wireless device 22 transmits in a report beam identifiers and/or DL RS indices (e.g., SSB index X1 for future time occasion t1, SSB index X2 for future time occasion t1+T′, SSB index X3 for future time occasion t1+2T′, . . . , SSB X_{F} for future time occasion t1+(F−1)T′) and receives in response the indication for PDSCH. Based on the response, the wireless device 22 updates the TCI state for PDSCH with QCL source=SSB index X1 in time occasion t1, the TCI state for PDSCH with QCL source=SSB index X2 in time occasion t1+2T′ . . . , and the TCI state for PDSCH with QCL source=SSB X_{F} in time occasion t1+(F−1)T′).

In some embodiments, the wireless device 22 transmits in the report beam identifiers and/or DL RS indices (e.g., SSB index X1 for future time occasion t1, SSB index X2 for future time occasion t1+T′, SSB index X3 for future time occasion t1+2T′, . . . . SSB X_{F} for future time occasion t1+(F−1)T′) and receives in response the indication for both PDSCH and PDCCH. Based on the received indication, the wireless device 22 updates, the TCI state for PDSCH and PDCCH with QCL source=SSB index X1 in time occasion t1, the TCI state for PDSCH and PDCCH with QCL source=SSB index X2 in time occasion t1+2T′, and the TCI state for PDSCH and PDCCH with QCL source=SSB X_{F} in time occasion t1+(F−1)T′).

In some embodiments, the indication includes an indication that this is for a unified TCI state, i.e., all associated physical channel (or physical channels, if multiple) associated to the TCI state(s) are to be updated in the future time occasions. The physical channel indicated may be e.g. PDCCH, PDSCH, PUCCH, PUSCH, RACH, etc.

In some embodiments, the indication includes the type of update, such as one of more of: activation, deactivation, addition, release, applying, etc.

In some embodiments, the indication includes the type of update and may be set per beam and/or DL RS which has been reported.

In some embodiments, the indication includes an indication of the serving cell (e.g., Serving cell index) in which the TCI state to be updated is configured.

In some embodiments, the indication includes a list of TCI states to be updated.

In some embodiments, the indication the wireless device 22 receives indicates to the wireless device 22 that the one or more beams included in the report are to be updated by the wireless device 22 autonomously at the respective future time occasions, but only up to a maximum time occasion.

In some embodiments, the wireless device 22 reports SSB index X1 for future time occasion t1, SSB index X2 for future time occasion t1+T′, SSB index X3 for future time occasion t1+2T′, . . . , SSB XF for future time occasion t1+(F−1)T′; the wireless device 22 receives the indication in response from the network node 16 indicating the wireless device 22 performs the autonomous updates up to the time occasion t1+f*T′, wherein f<F.

In some embodiments the indication includes the value ‘f’, indicating that the wireless device 22 performs the autonomous update up to the f-th prediction out of the 1 . . . F predictions included in the report.

In some embodiments the indication includes the value t1+f*T′ indicating that the wireless device performs the autonomous update up to the time occasion t1+f*T′.

In some embodiments, the wireless device 22 receives a second indication (and/or message) from the network node 16 cancelling the previously received indication from the network node 16 for autonomously updating one of its configured beams at one or more determined time occasions after the reception of the indication. At t0 the wireless device 22 receives the indication from the network node 16 for autonomously updating one of its configured beams at one or more determined time occasions (e.g., t1, t1+T′, t1+2T′, . . . , t1+(F−1)T′) after the reception of the indication. At a point in time before the time occasion t1+(F−1)T′ the wireless device 22 receives the second indication, cancelling all subsequent updates.

In some embodiments, the wireless device 22 cancels a previously received indication from the network node 16 for autonomously updating one of its configured beams at one or more determined time occasions after the reception of the indication upon one or more of the following events:
Transition to RRC IDLE state or RRC INACTIVE state;
Radio Link Failure;
Beam Failure Detection;
Handover and/or any other reconfiguration with sync procedure;
Re-establishment procedure.
In some embodiments, the wireless device 22 receives a second indication (and/or message) from the network node 16 modifying the previously received indication from the network node 16 for autonomously updating one of its configured beams at one or more determined time occasions after the reception of the indication.

In some embodiments, at t0 the wireless device 22 receives the indication from the network node 16 for autonomously updating one of its configured beams at one or more determined time occasions (e.g., t1, t1+T′, t1+2T′, . . . , t1+(F−1)T′) after the reception of the indication for performing a first type of update, e.g., activation of TCI state. At a point in time before the time occasion t1+(F−1)T′, the wireless device 22 receives the second indication, modifying the first type of update to deactivation of TCI state, for example.

In some embodiments, the feature is configured at the wireless device 22 as an additional robustness mechanism, i.e., the wireless device 22 may still receive a MAC CE from the network node 16 for updating the beam configuration (e.g., activate or deactivate TCI state) at one of the future time occasions for which the wireless device 22 has been authorized to autonomously update the beam configuration. It may work/function as follows: at a future time occasion t1+f*T′, the wireless device 22 starts a timer Txxx and:

If the wireless device 22 receives a command from the network node 16 that updates the beam configuration while the timer Txxx is running (e.g., MAC CE or DCI), the wireless device 22 updates the beam configuration according to the received command, stops the time Txxx and ignores the autonomous update for that time occasion t1+f*T′. The other future time occasions and their associated autonomous updates may still be valid).

If the timer Txxx expires and the wireless device 22 does not receive an update of beam configuration from the network node 16, the wireless device 22 autonomously updates the beam configuration according to the indication. In other words, the wireless device 22 may perform the autonomous update at the expiry of the timer Txxx, so that in t1+f*T′+Txxx value.

Other events may lead to the stop of the timer such as: transition to RRC IDLE state or RRC INACTIVE state, Radio Link Failure, Beam Failure Detection, Handover and/or any other reconfiguration with sync procedure, Re-establishment procedure.

In some embodiments, the value of the time timer Txxx is configured at the wireless device, e.g., by the network/network node 16.

In some embodiments, the wireless device 22 may report the best or K-best predicted beams (beam index X_{i,j} where i=0,1, . . . , F−1 and j=1,2, . . . , K) for each future time occasion (wherein each future time occasion is pre-determined and/or configured), such as, for example:
beam index X_{0,j} for future time occasion t1, where i=0 and j=1,2, . . . , K;
beam index X_{1,j} for future time occasion t1+T′, where i=1 and j=1,2, . . . , K;
beam index X_{2,j} for future time occasion t1+2T′, where i=2 and j=1,2, . . . , K;
. . .
beam index X_{F-1,j} for future time occasion t1+(F−1)T′, where i=F−1 and j=1,2, . . . , K.

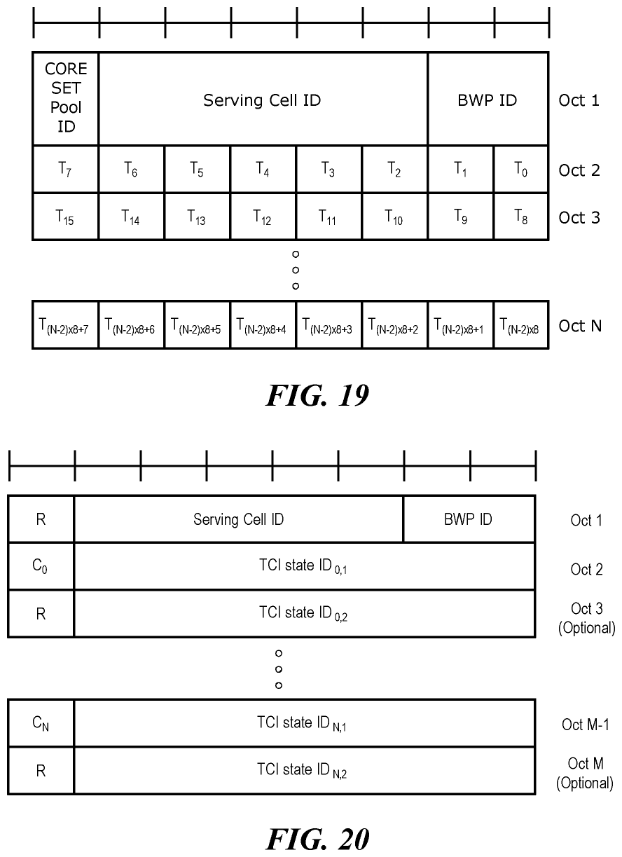

In some embodiments, the wireless device 22 may report only one predicted beam (i.e., K=1). Then, the network node 16 may use the TCI state Activation/Deactivation for WD-specific PDSCH MAC-CE as specified in, for example, 3GPP TS 38.321 section 6.1.3.14. An example is illustrated in FIG. 19. The TCI state Activation/Deactivation for WD-specific PDSCH MAC-CE is used to activate the TCI states. In the example of FIG. 19, the maximum number of activated TCI codepoint is 8 and the maximum number of TCI states mapped to a TCI codepoint is 1 (i.e., one TCI state ID is mapped to one TCI codepoint).

In the example of FIG. 19, the Tᵢ field indicates the activation/deactivation status of the TCI state with TCI-StateId i. Otherwise, the MAC entity ignores the Tᵢ field. The Tᵢ field may be set to 1 to indicate that the TCI state with TCI-StateId i may be activated and mapped to the codepoint of the DCI TCI field, as specified in, for example, 3GPP TS 38.214. The Tᵢ field may be set to 0 to indicate that the TCI state with TCI-StateId i may be deactivated and not mapped to the codepoint of the DCI TCI field. The codepoint to which the TCI State is mapped may be determined by its ordinal position among all the TCI States with Tᵢ field set to 1.

In some embodiments, if there are the following 8 fields {T₃, T₇, T₉, T₁₄, T₁₇, T₂₅, T₃₀, T₄₅} set to 1, then each codepoint value {0,1,2,3,4,5,6,7} is set as {3, 7, 9, 14, 17, 25, 30, 45}, respectively. Then, when the wireless device 22 receives the indication with DCI TCI field=011 (i.e., the codepoint value 3 is selected), the wireless device 22 knows that the TCI state ID 14 could be used as the QCL source.

This embodiment has no impact on existing standards, i.e., does not require changing one or more existing 3GPP standards.

In some embodiments, the wireless device 22 may report up to two predicted beams (i.e., K=2). Then, the network/network node 16 may use the Enhanced TCI States Activation/Deactivation for WD-specific PDSCH MAC-CE as specified in, for example, 3GPP TS 38.321 section 6.1.3.24, to activate the TCI states. An example is shown in FIG. 20, where the maximum number of activated TCI codepoint is 8 and the maximum number of TCI states mapped to a TCI codepoint is 2 (i.e., two TCI state IDs are mapped to one TCI codepoint).

The Reserved bit (R) may be set to 0 by default. The Cᵢ field indicates whether the octet containing TCI state ID_{i,2} is present. If Cᵢ=1, the octet containing TCI state ID_{i,2} is present. If Cᵢ=0, the octet containing TCI state ID_{i,2} is not present.

The TCI state ID_{i,j} field indicates the TCI state identified by TCI-StateId as specified in, for example, 3GPP TS 38.331, where i is the index of the codepoint of the DCI TCI field as specified in TS 38.212, and TCI state ID_{i,j} denotes the j^{th} TCI state indicated for the i^{th} codepoint in the DCI TCI field. The TCI codepoint to which the TCI States are mapped may be determined by its ordinal position among all the TCI codepoints with sets of TCI state ID_{i,j} fields, In other words, the first TCI codepoint with TCI state ID_{0,1} and TCI state ID_{0,2} may be mapped to the codepoint value 0, the second TCI codepoint with TCI state ID_{1,1} and TCI state ID_{1,2} may be mapped to the codepoint value 1 and so on. The TCI state ID_{i,2} is optional based on the indication of the Cᵢ field.

In some embodiments, when Cᵢ=1 for all of possible values of i and the wireless device 22 receives the indication with DCI TCI field=011 (i.e., the codepoint value 3 is selected), then the wireless device 22 knows that the TCI state ID_{3,1} and TCI state ID_{3,2} could be used as the QCL source.

In some embodiments, when Cᵢ=1 for parts of all values of i (C₀=1, C₃=1, and C₅=1) and if the wireless device 22 receives the indication with DCI TCI field=011 (i.e., the codepoint value 3 is selected), the wireless device 22 knows that the TCI state ID_{3,1} and TCI state ID_{3,2} could be used as the QCL source.

In some embodiments, when Cᵢ=1 for parts of all value of i (C₀=1, C₃=0, and C₅=1) and if the wireless devices 22 receives the indication with DCI TCI field=011 (i.e., the codepoint value 3 is selected), the wireless device 22 knows that only the TCI state ID_{3,1} could be used as the QCL source.

The Reserved bit (R) for each TCI state ID_{i,2} could be used to as an indicator (set as 0 or 1) to indicate if the wireless device 22 should apply the TCI state ID for the associated future time instance or not (e.g. a “1” may indicate that the wireless device 22 should apply the TCI State ID for the associated future time instance, and a “0” may indicate that the wireless device 2 should not apply the TCI State ID for the associated future time instance).

Note that this embodiment has no impact on existing standards, e.g., does not require changing one or more existing 3GPP standards for the embodiment to be in compliance with such standards.

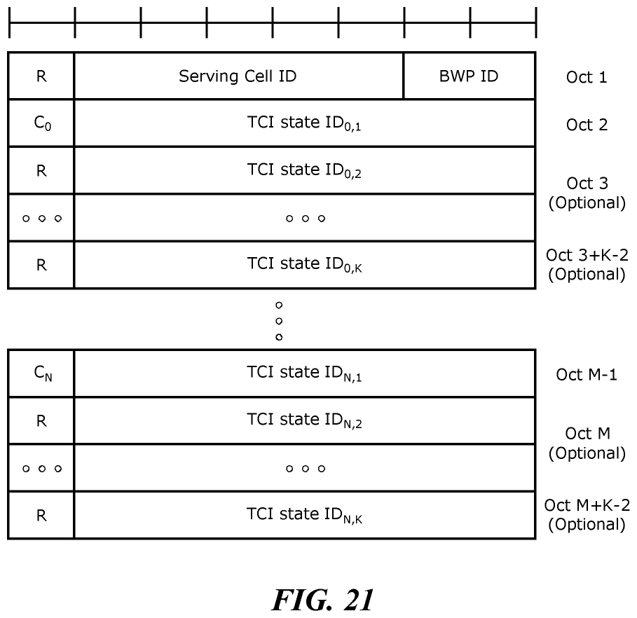

In some embodiments, wireless device 22 may report up to K predicted beams. Then, the network/network node 16 may use the Enhanced TCI States Activation/Deactivation for WD-specific PDSCH MAC-CE with additional modifications as shown in FIG. 21, to activate the TCI states. The example of FIG. 21 is based on an example from 3GPP TS 38.321 section 6.1.3.24, where the maximum number of activated TCI codepoint is 8 and the maximum number of TCI states mapped to a TCI codepoint is K (i.e., K TCI state IDs are mapped to one TCI codepoint).

The Reserved bit (R) may be set to 0 by default. The Cᵢ field indicates whether the octet containing TCI state ID_{i,k} for k=2,3, . . . , K is present. If Cᵢ=1, the octet containing TCI state ID_{i,k} for k=2,3, . . . , K is present. If Cᵢ=0, the octet containing TCI state ID_{i,k} for k=2,3, . . . , K is not present.

The TCI state ID_{i,j} field indicates the TCI state identified by TCI-StateId as specified in, for example, 3GPP TS 38.331, where i is the index of the codepoint of the DCI TCI field as specified in, for example, 3GPP TS 38.212 and TCI state ID_{i,j} denotes the j^{th} TCI state indicated for the i^{th} codepoint in the DCI TCI field. The TCI codepoint to which the TCI states are mapped may be determined by its ordinal position among all the TCI codepoints with sets of TCI state ID_{i,j} fields. In other words, the first TCI codepoint with TCI state ID_{0,k} for k=1,2, . . . , K may be mapped to the codepoint value 0, the second TCI codepoint with TCI state ID_{1,k} for k=1,2, . . . , K may be mapped to the codepoint value 1 and so on. The TCI state ID_{i,k} for k=2,3, . . . , K is optional based on the indication of the Cᵢ field.

In some embodiments, when Cᵢ=1 for all of possible values of i and the wireless device 22 receives the indication with DCI TCI field=011 (i.e., the codepoint value 3 is selected), the wireless device 22 knows that the TCI state ID_{3,k} for k=1,2, . . . , K could be used as the QCL source.

In some embodiments, when Cᵢ=1 for parts of all values of i (C₀=1, C₃=1, and C₅=1) and if the wireless device 22 receives the indication with DCI TCI field=011 (i.e., the codepoint value 3 is selected), then the wireless device 22 knows that the TCI state ID_{3,k} for k=1,2, . . . , K could be used as the QCL source.

In some embodiments, when Cᵢ=1 for parts of all values of i (C₀=1, C₃=0, and C₅=1) and if the wireless device 22 receives the indication with DCI TCI field=011 (i.e., the codepoint value 3 is selected), then the wireless device 22 knows that only the TCI state ID_{3,1} could be used as the QCL source.

The Reserved bit (R) for each TCI state ID_{i,k} (k=2,3, . . . , K) may be used as an indicator (set as 0 or 1) to indicate if the wireless device 22 should apply the TCI state ID for the associated future time instance or not. For example, a “1” may indicate that the wireless device 22 should apply the TCI State ID for the associated future time instance, and a “0” may indicate that the wireless device 22 should not apply the TCI State ID for the associated future time instance.

Note that this embodiment may have some impacts on the current standards, i.e., may require one or more changes to one or more existing 3GPP standards for this embodiment to be implemented in compliance with such standards. The FIG. 6.1.3.24-1 in 3GPP TS 38.321 section 6.1.3.24 may need additional modifications in accordance with the teaching described herein.

Some embodiments may include one or more of the following:
Embodiment A1. A network node configured to communicate with a wireless device, the network node configured to, and/or including a radio interface and/or including processing circuitry configured to:

cause transmission of a reference signal beam sweep of a first set of beams;

receive an indication of a prediction of a first beam from a second set of beams for use in at least one future time instance, the prediction of the first beam from the second set of beams being based on the reference signal beam sweep of the first set of beams;

determine for the wireless device to apply the first beam in at least one future time instance; and

cause transmission of an indication indicating to for the wireless device to apply the first beam in at least one future time instance.
Embodiment A2. The network node of Embodiment A1, wherein the applying of the first beam in at least one future time instance occurs without causing transmission of a medium access control, MAC, control element, CE, and downlink control information, DCI, associated with the first beam in the at least one future time instance.
Embodiment A3. The network node of any one of Embodiments A1-A2, wherein the reference signal is a channel state information-reference signal, CSI-RS.
Embodiment A4. The network node of any one of Embodiments A1-A3, wherein the indication corresponds to at least one transmission configuration indication, TCI, state being activated for the at least one future time instance.
Embodiment B1. A method implemented in a network node that is configured to communicate with a wireless device, the method comprising:

causing transmission of a reference signal beam sweep of a first set of beams;

receiving an indication of a prediction a first beam from a second set of beams for use in at least one future time instance, the prediction of the first beam from the second set of beams being based on the reference signal beam sweep of the first set of beams;

determining for the wireless device to apply the first beam in at least one future time instance; and

causing transmission of an indication indicating to for the wireless device to apply the first beam in at least one future time instance.
Embodiment B2. The method of Embodiment B1, wherein the applying of the first beam in at least one future time instance occurs without causing transmission of a medium access control, MAC, control element, CE, and downlink control information, DCI, associated with the first beam in the at least one future time instance.
Embodiment B3. The method of any one of Embodiments B1-B2, wherein the reference signal is a channel state information-reference signal, CSI-RS
Embodiment B4. The method of any one of Embodiments B1-B3, wherein the indication corresponds to at least one transmission configuration indication, TCI, state being activated for the at least one future time instance.
Embodiment C1. A wireless device configured to communicate with a network node, the wireless device configured to, and/or comprising a radio interface and/or processing circuitry configured to:

measure a reference signal beam sweep of a first set of beams;

predict a first beam from a second set of beams for use in at least one future time instance, the prediction of the first beam from the second set of beams being based on the measured reference signal beam sweep of the first set of beams;

report the prediction of the first beam; and

receive an indication indicating to apply the first beam in at least one future time instance.
Embodiment C2. The wireless device of Embodiment C1, wherein the applying of the first beam in at least one future time instance occurs without receiving a medium access control, MAC, control element, CE, and downlink control information, DCI, associated with the first beam in the at least one future time instance.
Embodiment C3. The wireless device of any one of Embodiments C1-C2, wherein the reference signal is a channel state information-reference signal, CSI-RS.
Embodiment C4. The wireless device of any one of Embodiments C1-C3, wherein the indication corresponds to at least one transmission configuration indication, TCI, state being activated for the at least one future time instance.
Embodiment D1. A method implemented in a wireless device that is configured to communicate with a network node, the method comprising:

measuring a reference signal beam sweep of a first set of beams;

predicting a first beam from a second set of beams for use in at least one future time instance, the prediction of the first beam from the second set of beams being based on the measured reference signal beam sweep of the first set of beams;

reporting the prediction of the first beam; and

receiving an indication indicating to apply the first beam in at least one future time instance.
Embodiment D2. The method of Embodiment D1, wherein the applying of the first beam in at least one future time instance occurs without receiving a medium access control, MAC, control element, CE, and downlink control information, DCI, associated with the first beam in the at least one future time instance.
Embodiment D3. The method of any one of Embodiments D1-D2, wherein the reference signal is a channel state information-reference signal, CSI-RS.
Embodiment D4. The method of any one of Embodiments D1-D3, wherein the indication corresponds to at least one transmission configuration indication, TCI, state being activated for the at least one future time instance.

Some examples may include one or more of the following:

### Examples

1. A method in a wireless device 22 for updating beam (TCI state) associated with a previous wireless device-sided beam prediction report, where the beam prediction report includes/indicates predicted network node beams from a set A of beams based on measurements of a set B of beams, the method includes
   a. Indicating to the network node a “DL Tx beam indication capability”
   b. Receiving a DL reference signal configuration
   c. Receiving a CSI report configuration associated with the DL reference signal configuration
   d. (Optional) Receiving a triggering of measurements on DL reference signals associated with a Set B of beams
   e. Performing measurements on DL reference signals associated with a Set B of beams, where the measurements are performed on one or more Measurements time occasions (K>=1), within a certain time window T1
   f. Computing predicted channel state information for the beams belonging to the Set A of beams for one or more indicated or determined Future time instances (F >=1). where the Future time instances are located within a certain time window T2
   g. Signal a Beam prediction report, containing the best predicted beams from set A of beams per indicated or determined future time instance (F)
   h. Receive a Predicted beam indication associated with the Beam prediction report
   i. Update the activated TCI state according to the received Predicted beam indication
2. Example 1 and where “DL Tx beam indication capability” (1a) includes one or more of
   a. Support of DCI based beam indication
   b. Support of MAC-CE based beam indication
   c. Support of automatic TCI state activation based on reported predicted beams.
3. Example 1 and where a single beam is reported per future time instance in the Beam prediction report (1g)
4. Example 3 and where a MAC-CE is used to indicate if the wireless device should apply (e.g., update, activate, etc.) the predicted beam for one or more of the future time instances (1h)
5. Example 3 and where DCI is used to indicate if the wireless device should apply the predicted beam for one or more of the future time instances (1h)
6. At least one of Examples 3, 4 and 5 and where a single-bit bitfield is used to indicate if the wireless device 22 should follow/apply the predicted beams for all of the future time instances (F) or not apply the predicted beam for any of the future time instances (e.g., “1” means the wireless device 22 should follow all the reported beam predictions and change to the corresponding TCI state at the associated future time instances, and a “0” means the wireless device 22 should not follow any of the beam predictions and hence not do perform any TCI state updates)
7. At least one of Examples 3,4 and 5, and where a single bitfield is used to indicate which of the future time instances the predicted beam should be applied for (e.g., assume the wireless device reports a best beam for each of three future time instances, then a bit string “101” would indicate to the wireless device 22 to switch to a TCI state associated with the reported beam for the first future time instance, and change to a TCI state associated with the reported beam associated with the third future time instance, and not do any TCI state update for the second future time instance)
8. Example 7 and where the length of the bitstring is equal to the total number of preconfigured future time instances, the wireless device 22 should report a predicated beam for (in case the wireless device is preconfigured with the number of future time instances to report a predicted beam for)
9. Example 8 and where the length of the bitstring is equal to the maximum number of future time instances, the wireless device 22 is allowed to report (in case the wireless device 22 is configured with a maximum number of future time instances to report a predicted beam for but the wireless device 22 decides how many future time instances that actually is reported)
10. At least one of Examples 3, 4, and 5, where a single bitfield is used to indicate how many of the reported future time instances the wireless device should apply the predicted beam for (e.g., if the bitfield indicates the number “2”, then the predicted beams (TCI states) of the first two future time instances should be automatically applied by the wireless device, and the wireless device should not update the TCI state for the remaining reported future time instances)
11. Example 1 and where N (N>1) beams are reported per future time instance in the Beam prediction report (1g)
12. Example 11 and where a MAC-CE is used to indicate if the wireless device should apply one of the predicted beams for one or more of the future time instances (1h)
13. Example 11 and where DCI is used to indicate if the wireless device should apply one of the predicted beams for one or more of the future time instances (1h)
14. At least one of Examples 11, 12 and 13, and where F number of bitfields is used to indicate which of the predicted beams that should be applied for respective future time instance (e.g., assume the wireless device reports four beams for each of three future time instances, then three bitfields, each with four codepoints could be used to indicate which of the four beams that should be applied for each of the three future time instance. The wireless device may then automatically switch to the TCI state associated with the indicated beam for respective future time instance at that future time instance)
15. Example 14 and where one codepoint of each bitfield is used to indicate that none of the predicted beams for a future time instance should be applied (i.e., don't perform TCI state update at this future time instance)
16. At least one of Examples 1 and 2 and where the each of the best predicted beams reported in the Beam prediction report is associated with a TCI state, and where all or a subset of all TCI states associated with a Beam prediction report are automatically activated (instead of using the TCI state activation/Deactivation for WD-specific PDSCH MAC-CE as specified in, for example, 3GPP Technical Specification (TS) 38.321 section 6.1.3.14 to activate the TCI states, which may require additional signaling overhead and latency)
17. Example 16 and where each of the activated TCI states is associated with a TCI field codepoint in a DCI (e.g., DCI 1_1 in NR)
18. At least one of Examples 16 and 17 and where the Predicted beam indication is performed by using a TCI field in DCI to indicate one of the TCI states that was activated based on the Beam prediction report (i.e., the actual indication of a TCI state may be performed in a similar way as in Legacy NR, it is just that the TCI states are activated based on the Beam prediction report instead of an explicit DL MAC-CE to save overhead signaling and latency)
19. Example 5 and where a single bitfield in DCI is used to indicate if and/or which of the reported predicted beams for an associated future time instance should be applied or not, and where the timing of the DCI determines the association with a future time instance (for example, a DCI received after the start of a future time instance F1, but before a future time instance F2 (including potential processing delay), is associated with the future time instance F2)
20. Example 19 and where a single predicted beam is reported per future time instance and a single bit bitfield in DCI is used to indicate if the wireless device 22 should apply the predicted reported beam for the associated future time instance or not (e.g., a “1” may indicate that the wireless device 22 should apply the reported predicted beam for the associated future time instance, and a “0” can indicate that the wireless device 22 should not apply the reported predicted beam for the associated future time instance)
21. Example 19 and where Y predicted beams are reported per future time instance and a bitfield with up to Y+1 codepoints in DCI is used to indicate if the wireless device 22 should apply one of the Y predicted beams from the beam report for an associated future time instance or if the wireless device 22 should not apply any of the reported predicted beam for an associated future time instance (e.g., codepoint “0” may indicate that the wireless device 22 should not apply any of the reported predicted beams for the associated future time instance, and the codepoints 1 to Y may indicate that the wireless device 22 should apply one of the Y reported predicted beams for the associated future time instance).
22. At least one of Examples 1-21 and where each Beam prediction report is associated with a Beam prediction report ID, and where a Predicted beam indication signaled in DCI or MAC-CE explicitly indicates the Beam prediction report ID to indicate which Beam prediction report the beam indication is associated with.
23. At least one of Examples 1-22 and where a Predicted beam indication signaled in DCI or MAC-CE is implicitly associated with a Beam prediction report.
24. Example 23 and where a Predicted beam indication is associated with the last transmitted Beam prediction report (including potential processing/signaling delay)
25. At least one of Examples 1 and 2 and where each of the best two predicted beams reported in the Beam prediction report is associated with a TCI state ID, and where the TCI state IDs associated with a Beam prediction report are activated using the Enhanced TCI States Activation/Deactivation for WD-specific PDSCH MAC-CE as specified in, for example, 3GPP TS 38.321 section 6.1.3.24.
26. Example 25 and where two activated TCI states (i.e., TCI state ID) are associated with one codepoint of the DCI field ‘Transmission Configuration Indication’ (e.g. DCI 1_1 in NR).
27. At least one of Examples 25 and 26 and where the Predicted beam indication is performed by using a TCI field in DCI to indicate two TCI states that were activated based on the Beam prediction report.
28. Example 27 and where the maximum number of activated TCI codepoint is 8 and the maximum number of TCI states mapped to a TCI codepoint is 2 (i.e., two TCI state IDs are mapped to one TCI codepoint).

Hence, one or more embodiments described herein enable overhead and latency efficient beam indication associated with a wireless device-sided beam prediction report for 5G advance and/or 6G.

Some embodiments address a problem that a beam report transmitted by a WD may be transmitted when the quality of a current beam is lower than acceptable and another beam has much better quality, so that the reception of the MAC CE to update the beam may need to occur in a beam with poor quality (which is still the beam the wireless device 22 is monitoring). This may lead to the need for retransmissions, which may delay the wireless device 22 reception of the command, and/or the wireless device 22 may not properly receiving the command, which may lead to Beam Failure Detection (BFD) and/or Radio Link Failure (RLF). In addition to this problem, even if radio conditions are acceptable upon reception of MAC CEs for updating TCI state(s), there is still a significant amount of signaling in terms of reports and responses from the network, which represents an overhead in the air interface and energy consumption at the wireless device 22 for receiving the command in response to a report.

Hence, the wireless device 22 autonomously updating its configured beams and/or TCI states and/or CSI measurement configuration(s) without the need to receive/process/etc. a MAC CE and/or DCI at these future occasions may improve the robustness of the connection.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flow chart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
3GPP 3rd Generation Partnership Project
5G Fifth Generation
ACK Acknowledgement
AI Artificial Intelligence
AoA Angle of Arrival
CORESET Control Resource Set
CSI Channel State Information
CSI-RS CSI Reference Signal
DCI Downlink Control Information
DoA Direction of Arrival
DL Downlink
DMRS Downlink Demodulation Reference Signals
FDD Frequency-Division Duplex
FR2 Frequency Range 2
HARQ Hybrid Automatic Repeat Request
ID identity
gNB gNodeB
MAC Medium Access Control
MAC-CE MAC Control Element
ML Machine Learning
NR New Radio
NW Network
OFDM Orthogonal Frequency Division Multiplexing
PBCH Physical Broadcast Channel
PCI Physical Cell Identity
PDCCH Physical Downlink Control Channel
PDSCH Physical Downlink Shared Channel
PRB Physical Resource Block
QCL Quasi co-located
RB Resource Block
RRC Radio Resource Control
RSRP Reference Signal Strength Indicator
RSRQ Reference Signal Received Quality
RSSI Received Signal Strength Indicator
SCS Subcarrier Spacing
SINR Signal to Interference plus Noise Ratio
SSB Synchronization Signal Block
RL Reinforcement Learning
RS Reference Signal
Rx Receiver
TB Transport Block
TDD Time-Division Duplex
TCI Transmission configuration indication
TRP Transmission/Reception Point
Tx Transmitter
UE User Equipment
UL Uplink
WD Wireless Device

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

41. A wireless device, WD, configured to communicate with a network node, the WD configured to:
receive from the network node a channel state information, CSI, reporting configuration indicating a first set of future time instances for CSI predictions to be reported by the WD to the network node;
perform a time sequence of measurements on a set of reference signal beams transmitted by the network node;
transmit to the network node a beam information report that includes CSI predictions for the first set of future time instances, the CSI predictions based at least in part on the time sequence of measurements; and
receive from the network node a beam indication indicating at least one selected beam for the CSI predictions to be autonomously applied by the WD at a second set of future time instances.

42. The WD of claim 41, wherein the beam indication indicates the second set of future time instances at which the at least one selected beam is to be autonomously applied by the WD.

43. A method in a wireless device, WD, configured to communicate with a network node, the method comprising:
receiving from the network node a channel state information, CSI, reporting configuration indicating a first set of future time instances for CSI predictions to be reported by the WD to the network node;
performing a time sequence of measurements on a set of reference signal beams transmitted by the network node;
transmitting to the network node a beam information report that includes CSI predictions for the first set of future time instances, the CSI predictions based at least in part on the time sequence of measurements; and
receiving from the network node a beam indication indicating at least one selected beam for the CSI predictions to be autonomously applied by the WD at a second set of future time instances.

44. The method of claim 43, wherein the beam indication indicates the second set of future time instances at which the at least one selected beam is to be autonomously applied by the WD.

45. The method of claim 43, wherein the beam indication indicates a first subset of the second set of future time instances for which a first selected beam is to be autonomously applied and indicates a second subset of the second set of future time instances for which a second selected beam is to be autonomously applied.

46. The method of claim 43, wherein beams of the set of reference signal beams are a subset of a set of beams for which the CSI predictions are selected.

47. The method of claim 43, wherein the beam indication indicates whether the WD is to activate a transmission configuration indicator, TCI, state at a time instance of the second set of future time instances.

48. The method of claim 43, wherein the beam indication indicates which one of a plurality of selected beams is to be applied at each time instance of the second set of future time instances.

49. The method of claim 43 wherein the first set of future time instances are equally distributed in time.

50. The method of claim 43, wherein a first subset of the first set of future time instances is separated from a second subset of the first set of future time instances by a gap.

51. The method of claim 43, wherein the beam information report includes an instantaneous beam report.

52. The method of claim 43, wherein the second set of future time instances is determined by the WD.

53. A network node configured to communicate with a wireless device, WD, the network node configured to:
transmit to the WD a channel state information, CSI, reporting configuration indicating a first set of future time instances for CSI predictions to be reported by the WD to the network node;
receive from the WD, a beam information report including indications of CSI predictions at the first set of future time instances based at least in part on a time sequence of measurements on a set of reference signal beams; and
transmit to the WD a beam indication for at least one selected beam for the CSI predictions to be autonomously applied by the WD at a second set of future time instances.

54. The network node of claim 53, wherein the beam indication indicates the second set of future time instances at which the at least one selected beam is to be autonomously applied by the WD.

55. A method in a network node configured to communicate with a wireless device, WD, the method comprising:
transmitting to the WD a channel state information, CSI, reporting configuration indicating a first set of future time instances for CSI predictions to be reported by the WD to the network node;
receiving from the WD, a beam information report including indications of CSI predictions at the first set of future time instances based at least in part on a time sequence of measurements on a set of reference signal beams; and
transmitting a beam indication for at least one selected beam for the CSI predictions to be autonomously applied by the WD at a second set of future time instances.

56. The method of claim 55, wherein the beam indication indicates the second set of future time instances at which the at least one selected beam is to be autonomously applied by the WD.

57. The method of claim 55, wherein the beam indication indicates a first subset of the second set of future time instances for which a first selected beam is to be autonomously applied and indicates a second subset of the second set of future time instances for which a second selected beam is to be autonomously applied.

58. The method of claim 55, wherein beams of the set of reference signal beams are a subset of a set of beams for which the CSI predictions are selected.

59. The method of claim 55, wherein the beam indication indicates whether the WD is to activate a transmission configuration indicator, TCI, state at a time instance of the second set of future time instances.

60. The method of claim 55, wherein the beam indication indicates which one of a plurality of selected beams is to be applied at each time instance of the second set of future time instances.
